(19) United States
(12) Patent Application Publication
(10) Pub. No.: US 2023/0422239 A1
(43) Pub. Date: Dec. 28, 2023

(54) METHOD AND APPARATUS FOR TRANSMISSION AND RECEPTION OF SIDELINK INFORMATION IN UNLICENSED BAND

(71) Applicant: Samsung Electronics Co., Ltd., Gyeonggi-do (KR)

(72) Inventors: Sungjin PARK, Gyeonggi-do (KR); Hyunseok RYU, Gyeonggi-do (KR); Hyewon YANG, Gyeonggi-do (KR); Junyung YI, Gyeonggi-do (KR)

(21) Appl. No.: 18/338,977

(22) Filed: Jun. 21, 2023

(30) Foreign Application Priority Data
Jun. 22, 2022 (KR) 10-2022-0076430

(51) Int. Cl. H04W 72/1263; H04W 72/25; H04L 1/1829

(52) U.S. Cl. CPC H04W 72/1263; H04W 72/25; H04L 1/1854

(57) ABSTRACT

The disclosure relates to a 5G or 6G communication system for supporting higher data transfer rates. The disclosure provides a method and an apparatus for performing SL transmission and reception in an unlicensed band. A method performed by a first terminal includes transmitting, to a second terminal, SL control information scheduling SL data for the second terminal; transmitting, to the second terminal, the SL data on a PSSCH; and receiving, from the second terminal, HARQ feedback associated with the SL data on a PSFCH resource. The SL control information includes an indicator indicating whether the PSFCH resource is included in a COT.

### CROSS-REFERENCE TO RELATED APPLICATION(S)

This application is based on and claims priority under 35 U.S.C. § 119 to Korean Patent Application No. 10-2022-0076430, which was filed in the Korean Intellectual Property Office on Jun. 22, 2022, the entire disclosure of which is incorporated herein by reference.

### BACKGROUND

### 1. Field

The disclosure relates generally to a method for transmitting and receiving sidelink (SL) information in a wireless communication system and, more specifically, to a configuration of SL information in an unlicensed band.

### 2. Description of Related Art

5^{th} generation (5G) mobile communication technologies define broad frequency bands such that higher transmission rates and new services are possible. 5G mobile communication technologies can be implemented in “sub 6 GHz” bands such as 3.5 GHz, and also in “above 6 GHz” bands, which may be referred to as mmWave, including 28 GHz and 39 GHz.

In addition, 6^{th} generation (6G) mobile communication technologies (e.g., referred to as beyond 5G systems) have considered for implementation in terahertz bands (e.g., 95 GHz to 3 THz bands) in order to accomplish transmission rates fifty times faster than 5G mobile communication technologies and ultra-low latencies one-tenth of mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input, multiple-output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for larger amounts of data transmission and a polar code for highly reliable transmission of control information, layer 2 (L2) pre-processing, and network slicing for providing a dedicated network specialized to a specific service.

There are ongoing discussions regarding improvements and performance enhancements of the initial 5G mobile communication technologies in view of services to be supported by newer 5G mobile communication technologies. For example, physical layer standardization has been performed regarding technologies such as vehicle-to-everything (V2X) for aiding driving determination by autonomous vehicles based on information regarding positions and states of vehicles transmitted by the vehicles and for enhancing user convenience, new radio (NR)-unlicensed (U) aimed at system operations conforming to various regulation-related requirements in unlicensed bands, NR user equipment (UE) power saving, a non-terrestrial network (NTN), which is UE-satellite direct communication for providing coverage in an area in which communication with terrestrial networks is unavailable, and positioning.

There has also been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponentially increase, and it is accordingly expected that enhanced functions and performances of mobile communication systems and integrated operations of connected devices will be necessary. To this end, new research is scheduled in connection with extended Reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for schemes to effectively provide these services.

### SUMMARY

The disclosure is provided to address at least the above-mentioned problems and/or disadvantages and to provide at least the advantages described below.

Accordingly, an aspect of the disclosure is to provide a method for configuring SL information in an SL communication system using an unlicensed band, and a method and an apparatus for transmitting and receiving the SL information.

In accordance with an aspect of the disclosure, a method performed by a first terminal in a communication system is provided. The method includes transmitting, to a second terminal, SL control information scheduling SL data for the second terminal, transmitting, to the second terminal, the SL data on a physical SL shared channel (PSSCH), and receiving, from the second terminal, a hybrid automatic repeat request (HARQ) feedback associated with the SL data on a physical SL feedback channel (PSFCH) resource, wherein the SL control information includes an indicator indicating whether the PSFCH resource is included in a channel occupancy time (COT).

In accordance with another aspect of the present disclosure, a method performed by a second terminal in a communication system is provided. The method includes receiving, from a first terminal, SL control information scheduling SL data, the SL control information including an indicator indicating whether a PSFCH resource is included in a COT, receiving, from the first terminal, the SL data on a PSSCH, identifying HARQ feedback associated with the SL data, and transmitting, to the first terminal, the HARQ feedback on the PSFCH resource based on a channel access procedure based on the indicator.

In accordance with another aspect of the present disclosure, a first terminal in a communication system is provided. The first terminal includes a transceiver and a controller coupled with the transceiver and configured to transmit, to a second terminal, SL control information scheduling SL data for the second terminal, transmit, to the second terminal, the SL data on a PSSCH, and receive, from the second terminal, a HARQ feedback associated with the SL data on a PSFCH resource, and wherein the SL control information includes an indicator indicating whether the PSFCH resource is included in a COT.

In accordance with another aspect of the present disclosure, a second terminal in a communication system is provided. The second terminal includes a transceiver and a controller coupled with the transceiver and configured to receive, from a first terminal, SL control information scheduling SL data, the SL control information including an indicator indicating whether a PSFCH resource is included in a COT, receive, from the first terminal, the SL data on a PSSCH, identify HARQ feedback associated with the SL data, and transmit, to the first terminal, the HARQ feedback on the PSFCH resource based on a channel access procedure based on the indicator.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates various scenarios of a communication system according to an embodiment;

FIG. 2 illustrates a V2X communication method established through a SL, according to an embodiment;

FIG. 3 illustrates a protocol of an SL UE, according to an embodiment;

FIG. 4 illustrates types of synchronization signals (SSs) that may be received by an SL UE, according to an embodiment;

FIG. 5 illustrates a frame structure of an SL system according to an embodiment;

FIG. 6 illustrates a channel access procedure in an unlicensed band in a wireless communication system according to an embodiment;

FIG. 7 illustrates a structure of an SL channel according to an embodiment;

FIG. 8 illustrates a relationship between a control and data channel and a feedback channel of an SL UE operating in a licensed band according to an embodiment;

FIG. 9 illustrates a method of configuring a gap duration of 25 μs or less in an unlicensed band according to an embodiment;

FIG. 10 illustrates a method of configuring a COT duration in an unlicensed band according to an embodiment;

FIG. 11 illustrates a UE requesting HARQ-acknowledgement (ACK) feedback according to an embodiment;

FIG. 12 illustrates a method for configuring a COT duration by a UE according to an embodiment;

FIG. 13 illustrates a UE according to an embodiment; and

FIG. 14 illustrates a base station according to an embodiment.

### DETAILED DESCRIPTION

Hereinafter, various embodiments of the disclosure will be described in detail with reference to the accompanying drawings. In the drawings, the same or like elements may be designated by the same or like reference signs. Furthermore, a detailed description of known functions or configurations that may make the subject matter of the disclosure unclear will be omitted.

In describing the embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

In the accompanying drawings, some elements may be exaggerated, omitted, or schematically illustrated. Further, the size of each element does not completely reflect the actual size. In the drawings, identical or corresponding elements are provided with identical reference numerals.

Advantages and features of the disclosure and ways to achieve them will be apparent by making reference to embodiments as described below in detail in conjunction with the accompanying drawings. However, the disclosure is not limited to the embodiments set forth below, but may be implemented in various different forms.

Each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, implement the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instructions that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, the term “unit” does not always mean software or hardware. The term “unit” may be constructed either to be stored in an addressable storage medium or to execute one or more processors. Therefore, a “unit” includes, e.g., software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or divided into a larger number of elements. Moreover, the elements and “units” may be implemented to reproduce one or more central processing units (CPUs) within a device or a security multimedia card. Furthermore, a “unit” in the embodiments may include one or more processors.

The following detailed description of embodiments of the disclosure is directed to NR as a radio access network and packet core as a core network (e.g., a 5G system, a 5G core network, or a next generation (NG) core), which are specified in the 5G mobile communication standards defined by the 3rd generation partnership project (3GPP), which is a mobile communication standardization group, but based on determinations by those skilled in the art, concepts of the disclosure may be applied to other communication systems having similar backgrounds or channel types through some modifications without significantly departing from the scope of the disclosure.

In a 5G system, in order to support network automation, a network data collection and analysis function (NWDAF), which is a network function that analyzes and provides data collected from a 5G network, may be defined. The NWDAF may collect/store/analyze information from 5G networks and provide the results to unspecified network functions (NFs), and the analysis results may be used independently in each NF.

In the following description, some of terms and names defined in the 3GPP standards (e.g., standards for 5G, NR, long term evolution (LTE), or other similar systems) may be used for the convenience of description. However, the disclosure is not limited by these terms and names, and may be applied in the same way to systems that conform other standards.

In the following, “A/B” may mean at least one of A or B.

In the following description, terms for identifying access nodes, terms referring to network entities, terms referring to messages, terms referring to interfaces between network entities, terms referring to various identification information, etc., are used for the sake of descriptive convenience. Therefore, the disclosure is not limited by the terms as used below, and other terms referring to subjects having equivalent technical meanings may be used.

In order to meet wireless data traffic demands that have increased after 4th generation (4G) communication system commercialization, efforts to develop an improved 5G communication system (i.e., NR) have been made. The 5G communication system has been designed to use resources in a mmWave band (e.g., a frequency band of 28 GHz) in order to achieve a high data transmission rate. In the 5G communication system, technologies such as beamforming, massive MIMO, FD-MIMO, array antennas, analog beam-forming, and large scale antennas are discussed to mitigate a propagation path loss in the mmWave band and increase a propagation transmission distance. In addition, unlike LTE, the 5G communication system supports various subcarrier spacings such as 30 kHz, 60 kHz, and 120 kHz including 15 kHz, and a physical control channel uses polar coding and a physical data channel uses an LDPC.

Furthermore, as waveforms for uplink (UL) transmissions, a cyclic prefix (CP) based orthogonal frequency division multiplexing (OFDM) (CP-OFDM) and a discrete Fourier transform spread OFDM (DFT-S-OFDM) may be used. While resources for HARQ retransmission in units of transport blocks (TBs) are allocated in LTE, resources for HARQ retransmission based on a code block group (CBG) including a plurality of code blocks (CBs) may be additionally allocated in 5G.

Accordingly, various attempts have been made to apply 5G communication systems to IoT networks. For example, technologies such as a sensor network, machine-to-machine (M2M), and machine type communication (MTC) may be implemented by beamforming, MIMO, and array antennas, which are 5G communication technologies. Application of a cloud radio access network (RAN) as the above-described big data processing technology may also be considered an example of convergence of the 5G technology with the IoT technology.

As described above, a plurality of services may be provided to a user in a communication system, and in order to provide the plurality of services to the user, a method of providing each service in the same time interval according to a characteristic thereof and an apparatus using the same are needed. Various services provided by the communication system are being researched, and one thereof is a service that satisfies requirements of low latency and high reliability.

In the case of vehicle communication, standardization of LTE-based V2X has been competed in 3GPP Rel-14 and Rel-15 based on the device-to-device (D2D) communication structure, and research on the development of V2X based on 5G NR is currently being conducted.

In NR V2X, unicast communication, groupcast communication (or multicast communication), and broadcast communication will be supported between UEs. Further, NR V2X aims at providing more evolved service such as platooning, advanced driving, extended sensor, and remote driving, unlike LTE V2X aiming at transmitting and receiving basic safety information required for driving of vehicles.

Since the above-described advanced service requires a high data rate, the NR V2X system may require a relatively wide bandwidth compared to the conventional 4G LTE V2X system. To this end, operation in a high frequency band should be supported, and a coverage problem caused by frequency characteristics through analog beamforming should be addressed. In such an analog beamforming system, a method and an apparatus for acquiring beam information between a transmission UE and a reception UE are required.

An aspect of the disclosure is to support the above-described scenario, and to provide a method for configuring SL broadcast information to perform SL synchronization between UEs, and a method and an apparatus for transmitting and receiving the SL broadcast information.

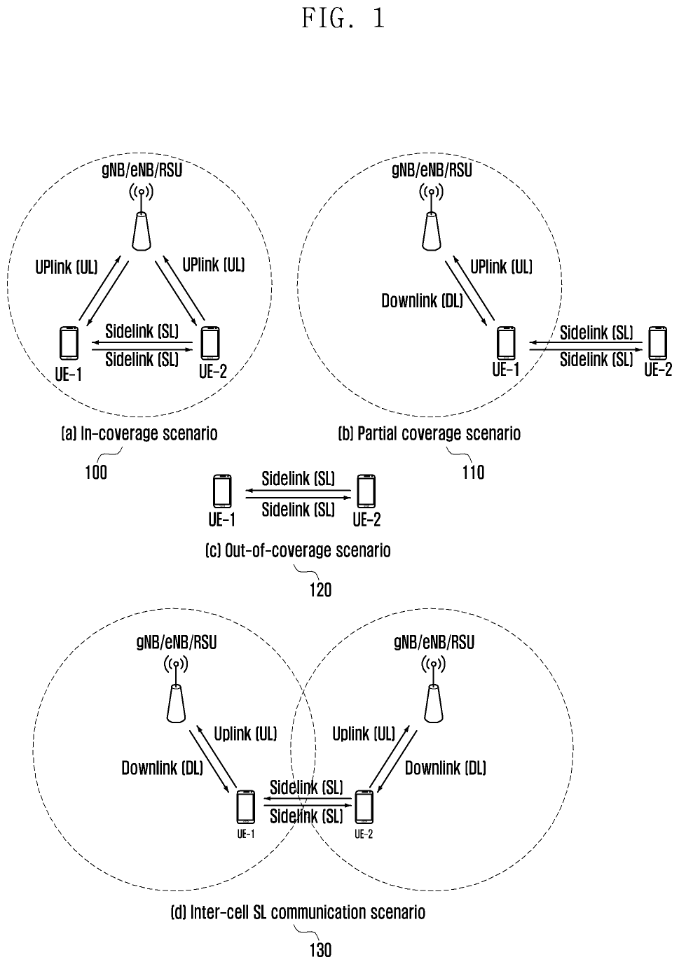

FIG. 1 illustrates various scenarios of a communication system according to an embodiment.

Referring to FIG. 1, in an in-coverage scenario 100, all V2X UEs (i.e., UE-1 and UE-2) are located within the coverage of a base station.

All V2X UEs located within the coverage of a base station may receive data and control information from the base station through downlink (DL) or transmit data and control information to the base station through UL. The data and the control information may include at least one of data and control information for V2X communication or data and control information for general cellular communication. The V2X UEs may transmit and receive data and control information for V2X communication through an SL.

In a partial coverage scenario 110, the UE-1 of the V2X UEs is located within the coverage of the base station and the UE-2 is located outside of the coverage of the base station.

The UE-1 located inside the coverage of the base station may receive data and control information from the base station through a DL or transmit data and control information to the base station through a UL. The UE-2 located outside the coverage of the base station is unable to receive data and control information from the base station through a DL and is unable to transmit data and control to the base station through a UL. However, the UE-2 may transmit and receive data and control information for V2X communication to and from the UE-1 through the SL.

In an out-of-coverage scenario 120, all of the V2X UEs are located outside of the coverage of the base station. Accordingly, the UE-1 and the UE-2 are unable to receive data and control information from the base station through the DL and are unable to transmit data and control information to the base station through the UL. The UE-1 and the UE-2 may transmit and receive data and control information for V2X communication through the SLs.

In an inter-cell SL communication scenario 130, the UEs are located in different cells and perform V2X communication. Specifically, a V2X transmission UE and a V2X reception UE access different base stations (e.g., in a radio resource control (RRC)-connected state) or camp on the base stations (e.g., in an RRC connection-released state, i.e., an RRC idle state). Although it is assumed that the UE-1 is a V2X transmission UE and the UE-2 is a V2X reception UE, alternatively, the UE-1 may be a V2X reception UE and the UE-2 may be a V2X transmission UE.

The UE-1 may receive a V2X-dedicated system information block (SIB) from the base station that the UE-1 accesses (or camps on) and the UE-2 may receive a V2X-dedicated SIB from another base station that the UE-2 accesses (or camps on). The V2X-dedicated SIB information that the UE-1 receives and the V2X-dedocated SIB information that the UE-2 receives may be the same as or different from each other. In case that the SIB information are different from each other, the UE-1 and the UE-2 may receive different information for SL communication via an SIB from a base station to which they access (or camp on). In this case, information may be required to be unified to perform SL communication between the UEs located in different cells.

Although FIG. 1 illustrates a V2X system including two UEs (i.e., the UE-1 and the UE-2) for convenience of explanation, the disclosure is not limited thereto.

The DL and the UL between the base station and the V2X UEs may be referred to as a Uu interface, and the SL between the V2X UEs may be referred to as a PC5 interface. Accordingly, the terms may be interchangeably used in the disclosure.

Herein, a UE may be a device supporting D2D communication, a vehicle supporting vehicular-to-vehicular (V2V) communication, a vehicle or a handset of a pedestrian (e.g., a smartphone) supporting vehicle-to-pedestrian (V2P) communication, a vehicle supporting vehicle-to-network (V2N) communication, or a vehicle supporting vehicle-to-infrastructure (V2I) communication. Further, the UE may refer to a road side unit (RSU) having a UE function, an RSU having a base station function, or an RSU having both base station functions and UE functions.

V2X communication may include D2D communication, V2V communication, or V2P communication, and there terms may be interchangeably used.

Herein, it is predefined that a base station may be a base station supporting both V2X communication and general cellular communication or a base station supporting only V2X communication. The base station may be a 5G base station (gNB), a 4G base station (eNB), or an RSU. Accordingly, unless specifically mentioned, the base station and the RSU may be the same concept and thus the terms may be interchangeably used.

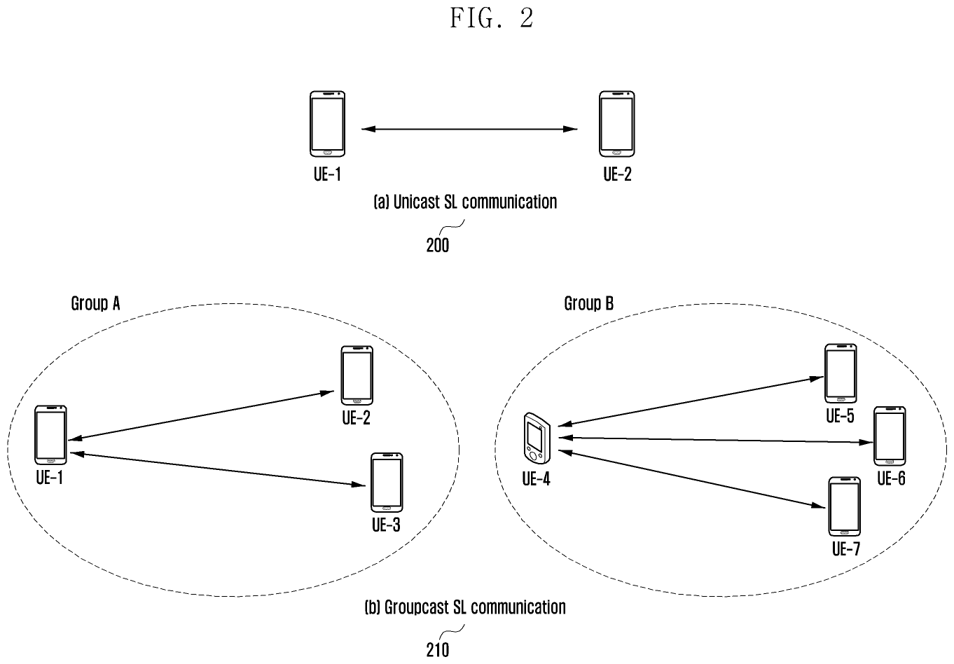

FIG. 2 illustrates a V2X communication method performed through an SL, according to an embodiment.

Referring to FIG. 2, in unicast SL communication 200, a transmission UE (UE-1) and a reception UE (UE-2) may communicate in one-to-one manner.

In groupcast (or multicast) communication 210, a transmission UE (UE-1 or UE-4) and a reception UE (UE-2, UE-3, UE-5, UE-6, or UE-7) may communicate in a one-to-many manner, which may be called groupcast or multicast.

In FIG. 2, UE-1, UE-2, and UE-3 form one group (group A) and establish groupcast communication, and UE-4, UE-5, UE-6, and UE-7 form another group (group B) and establish groupcast communication. Each UE may perform groupcast communication only within the group to which it belongs, and communication between different groups may be performed through unicast, groupcast, or broadcast communication. Although FIG. 2 illustrates that two groups are formed, the disclosure is not limited thereto.

Although not illustrated in FIG. 2, the V2X UEs may also perform broadcast communication. In broadcast communication, all V2X UEs may receive data and control information transmitted by the V2X transmission UE through the SL. For example, in groupcast communication 210, when it is assumed that UE-1 is a transmission UE for broadcast, UE-2, UE-3, UE-4, UE-5, UE-6, and UE-7 may be reception UEs for receiving data and control information transmitted by UE-1.

SL unicast, groupcast, and broadcast communication methods according to embodiments of the disclosure may be supported in in-coverage, partial-coverage, and out-of-coverage scenarios.

Resource allocation in the SL system may be performed by the following methods.

(1) Mode 1 Resource Allocation

Mode 1 resource allocation refers is scheduled by a base station (scheduled resource allocation). In mode 1 resource allocation, the base station may allocate resources used for SL transmission to RRC connected UEs in a dedicated scheduling method. The base station is able to manage resources of the SL, so that the scheduled resource allocation method may be effective for interference management and resource pool management (e.g., dynamic allocation and/or semi-persistent transmission).

In case that there is data to be transmitted to other UE(s), the RRC connected mode UE may transmit, to the base station, information indicating that there is data to be transmitted to other UEs, by using an RRC message or a medium access control (MAC) control element (CE). For example, the RRC message may be an SL UE information (SidelinkUEInformation) message or a UE assistance information (UEAssistanceInformation) message. The MAC CE may correspond to a scheduling request (SR) and a buffer status report (BSR) MAC CE including at least one of information on the size of data buffered for SL communication or an indicator for notification of a BSR for V2X communication.

The SL transmission UE receives resources scheduled by the base station, and thus a method of the mode 1 resource allocation may be applied when a V2X transmission UE is within the coverage of the base station.

(2) Mode 2 Resource Allocation

In mode 2, a SL transmission UE may autonomously select a resource (UE autonomous resource selection). More specifically, mode 2 includes a method of providing, by the base station, the UE with an SL transmission/reception resource pool for SL, as system information or an RRC message (e.g., an RRC reconfiguration message (RRCReconfiguration) or a PC5-RRC message), wherein the transmission UE having received the transmission/reception resource pool selects a resource pool and a resource according to a predetermined rule.

In the above example, the base station provides configuration information for the SL transmission/reception resource pool, and mode 2 may be applied in case that the SL transmission UE and a reception UE are in the coverage of the base station.

In case that the SL transmission UE and the reception UE exist outside the coverage of the base station, the SL transmission UE and the reception UE may perform a mode 2 operation in a preconfigured transmission/reception resource pool. A UE autonomous resource selection method may include zone mapping, sensing-based resource selection, random selection, etc.

(3) Preconfigured SL Transmission/Reception Resource Pool

Additionally, even if a UE is in the coverage of the base station, resource allocation or resource selection may not be performed in the scheduled resource allocation or UE autonomous resource selection mode, and in this case, the UE may perform SL communication via a preconfigured SL transmission/reception resource pool (preconfiguration resource pool).

The SL resource allocation methods according to the above-described embodiments may be applied to various embodiments of the disclosure.

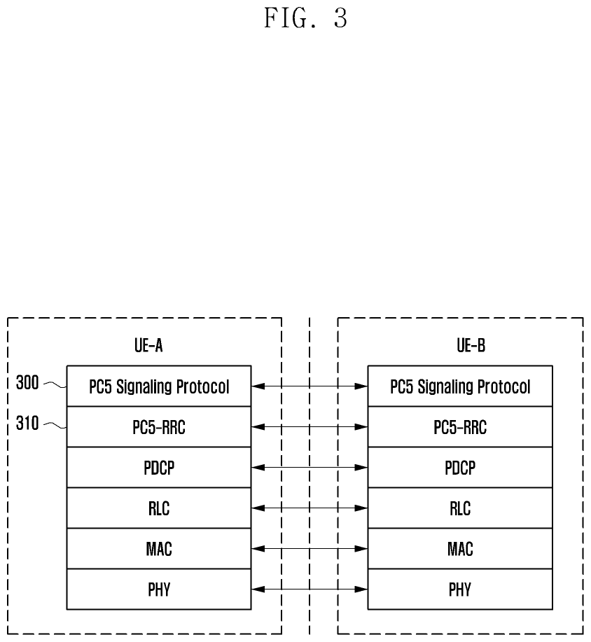

FIG. 3 illustrates a protocol of an SL UE according to an embodiment.

Referring to FIG. 3, although not illustrated therein, application layers of the UE-A and the UE-B may perform service discovery. The service discovery may include discovery of an SL communication scheme (e.g., unicast, groupcast, or broadcast) that will be performed by each UE. Therefore, in FIG. 3, it may be assumed that the UE-A and the UE-B have recognized to perform a unicast communication scheme via a service discovery procedure performed in the application layers. The SL UEs may acquire information on a transmitter identifier (ID) (e.g., a source ID) and a destination ID for SL communication through the above-described service discovery procedure.

When the above-described procedure is completed, a PC5 signaling protocol layer 300 may perform a D2D direct link connection setup procedure. Security configuration information for D2D direct communication may be exchanged.

When the D2D direct link connection setup is completed, a D2D PC5 RRC configuration procedure may be performed in the PC5 RRC layer 310 of FIG. 3. Information on the capabilities of the UE-A and the UE-B may be exchanged, and access stratum (AS) layer parameter information for unicast communication may be exchanged.

When the PC5 RRC setup procedure is completed, the UE-A and the UE-B may perform unicast communication.

In the description above, although unicast communication is described as an example, it may be extended to groupcast communication. For example, in case that the UE-A, the UE-B, and a UE-C (which is not illustrated in FIG. 3) perform groupcast communication, as mentioned above, the UE-A and the UE-B may perform service discovery for unicast communication, D2D direct link setup, and PC5 RRC setup procedures. Further, UE-A and the UE-C may also perform service discovery for unicast communication, D2D direct link setup, and PC5 RRC setup procedures.

The UE-B and the UE-C may perform service discovery for unicast communication, D2D direct link setup, and PC5 RRC setup procedures. That is, a PC5 RRC setup procedure for unicast communication, instead of a separate PC5 RRC setup procedure for groupcast communication, may be performed in a pair of a transmission UE and a reception UE that join groupcast communication. However, a PC5 RRC setup procedure for unicast communication is not always required to be performed in a groupcast method. For example, there may be a scenario of groupcast communication performed without PC5 RRC connection establishment, and in this case, a PC5 connection establishment procedure for unicast transmission may be omitted.

The PC5-RRC setup procedure for unicast or groupcast communication may be applied to in-coverage, partial coverage, and out-of-coverage scenarios as illustrated in FIG. 1. When UEs desiring to perform unicast or groupcast communication exist within the coverage of a base station, the corresponding UEs may perform the PC5-RRC setup procedure before or after performing DL or UL synchronization with the base station.

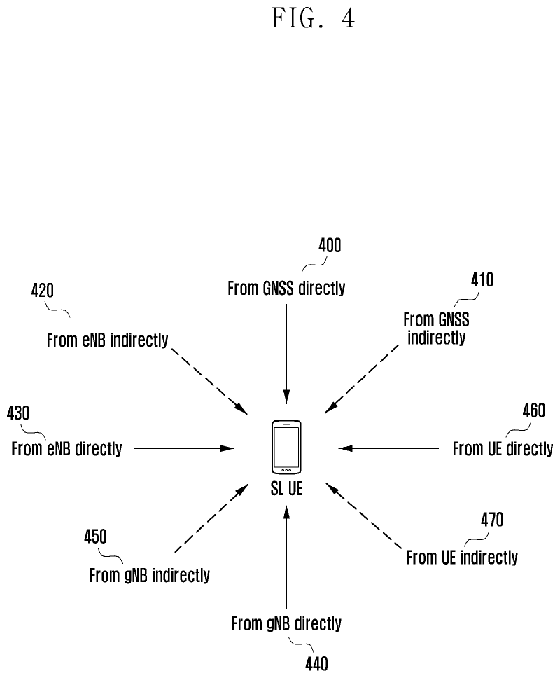

FIG. 4 illustrates types of SSs that may be received by an SL UE, according to an embodiment.

Specifically, the following SL SSs (SLSSs) may be received from various SL synchronization sources.
The SL UE may directly receive a synchronization signal from a global navigation satellite system (GNSS) or a global positioning system (GPS) 400. In this case, the SLSS source may be a GNSS.
The SL UE may indirectly receive a synchronization signal from the GNSS or GPS 410.

Receiving a synchronization signal indirectly from the GNSS may be understood as that an SL UE-A receives an SLSS transmitted by SL UE-1 that is directly synchronized with the GNSS. In this case, the SL UE-A may receive an SS from the GNSS through 2 hops.

As another example, an SL UE-2 that is synchronized with an SLSS transmitted by SL UE-1 that is synchronized with the GNSS may transmit the SLSS. The SL UE-A having received the SLSS may receive an SS from the GNSS through 3 hops. Similarly, the SL UE-A may receive an SS from the GNSS through 3 hops or more.

In this case, the SLSS source may be another SL UE synchronized with the GNSS.
The SL UE may directly receive an SS from the LTE base station (eNB) 430.

The SL UE may directly receive a primary SS (PSS) and/or a secondary SS (SSS) transmitted from the LTE base station.

In this case, the SLSS source may be the eNB.
The SL UE may indirectly receive an SS from the LTE base station (eNB) 420.

Receiving an SS indirectly from the eNB may refer to the SL UE-A receiving an SLSS transmitted by SL UE-1 that is directly synchronized with the eNB. The SL UE-A may receive an SS from the eNB through 2 hops.

As another example, an SL UE-2 that is synchronized with an SLSS transmitted by SL UE-1 that is directly synchronized with the eNB may transmit the SLSS. Upon receiving the SLSS, the SL UE-A may receive an SS from the eNB through 3 hops. Similarly, the SL UE-A may receive an SS from the eNB through 3 hops or more.

In this case, the SLSS source may be another SL UE synchronized with the eNB.
The SL UE may directly receive an SS from the NR base station (gNB) 440.

The SL UE may directly receive PSS (and/or SSS) transmitted from the NR base station.

In this case, the SLSS source may be a gNB.
The SL UE may indirectly receive an SS from the NR base station (gNB) 450.
Receiving an SS indirectly from the gNB may refer to another SL UE-A receiving an SLSS transmitted by the SL UE-1 that is directly synchronized with the gNB. The SL UE-A may receive an SS from the gNB through 2 hops.

As another example, an SL UE-2 that is synchronized with the SLSS transmitted by the SL UE-1 that is directly synchronized with the gNB may transmit the SLS S. Upon receiving the SLSS, the SL UE-A may receive an SS from the gNB through 3 hops. Similarly, the SL UE-A may receive an SS from the gNB through 3 hops or more.

In this case, the SLSS source may be another SL UE synchronized with the gNB.
The SL UE-A may directly receive an SS from another SL UE-B 460.

In case that SL UE-B does not detect an SLSS transmitted from the GNSS, gNB, eNB, or another SL UE as an SS source, the SL UE-B may transmit the SLSS based on its own timing. The SL UE-A may directly receive the SLSS transmitted by the SL UE-B.

In this case, the SLSS source may be a SL UE.
The SL UE-A may indirectly receive an SS from another SL UE-B 470.

Receiving an SS indirectly from SL UE-B may be understood as the SL UE-A receiving an SLSS transmitted by the SL UE-1 that is directly synchronized with the SL UE-B. The SL UE-A may receive an SS from the SL UE-B through 2 hops.

As another example, an SL UE-2, which is synchronized with the SLSS transmitted by the SL UE-1 directly synchronized with SL UE-B, may transmit the SLSS. Upon receiving the SLSS, the SL UE-A may receive an SS from SL UE-B through 3 hops. Similarly, the SL UE-A may receive an SS from the SL UE-B through 3 hops or more.

In this case, the SLSS source may be another SL UE synchronized with the SL UE.

The SL UE may receive SSs from the above-described various SS sources, and may perform synchronization of an SS, which is transmitted from an SS source having a higher priority according to a preconfigured priority.

For example, the following priorities may be pre-configured in descending order of an SS, i.e., in an order from an SS having a high priority to an SS having a low priority.

Case A

1) SS transmitted from the GNSS >2) SS transmitted by a UE performing synchronization directly with the GNSS >3) SS transmitted by a UE performing synchronization indirectly with the GNSS >4) SS transmitted from the eNB or gNB (hereinafter referred to as eNB/gNB)>5) SS transmitted by a UE performing synchronization directly with the eNB/gNB>6) SS transmitted by a UE performing synchronization indirectly with the eNB/gNB>7) SS transmitted by a UE that does not directly or indirectly synchronize with the GNSS and eNB/gNB.

Case A is an example in which the SS transmitted by the GNSS has the highest priority. Alternatively, a case in which the SS transmitted by the eNB/gNB has the highest priority may be considered, and the following priorities may be pre-configured.

Case B

1) SS transmitted from the eNB/gNB>2) SS transmitted by a UE performing synchronization directly with the eNB/gNB>3) SS transmitted by a UE performing synchronization indirectly with the eNB/gNB>4) SS transmitted from the GNSS >5) SS transmitted by a UE performing synchronization directly with the GNSS >6) SS transmitted by a UE performing synchronization indirectly with the GNSS >7) SS transmitted by a UE that is not performing synchronization directly or indirectly with the GNSS and eNB/gNB.

Whether the SL UE should follow the priority of case A or the priority of case B may be configured by the base station or pre-configured. More specifically, when the SL UE exists in the coverage of the base station (in-coverage), the base station may configure whether the SL UE should follow the priority of case A or case B via an SIB or RRC signaling.

In case that the SL UE exists outside the coverage of the base station (out-of-coverage), whether the SL UE should perform the SL synchronization procedure according to the priority of Case A or the priority Case B may be pre-configured.

When the base station configures the above-described case A for the SL UE via an SIB or RRC signaling, the base station may additionally configure whether or not the SL UE considers, in case A, priority 4 (when synchronizing with an SS transmitted from the eNB/gNB), priority 5 (when synchronizing with an SS transmitted by a UE performing synchronization directly with the eNB/gNB), and priority 6 (when synchronizing with an SS transmitted by a UE performing synchronization indirectly with the eNB/gNB). That is, when the above-described case A is configured and consideration of priority 4, priority 5, and priority 6 are additionally configured, all the above-described priorities of case A may be considered (i.e., from priority 1 to priority 7). However, when the above-described case A is configured and consideration of the priority 4, priority 5, and priority 6 is not configured, or when the above-described case A is configured and no consideration of priority 4, priority 5, and priority 6 is configured, the priority 4, priority 5, and priority 6 may be omitted in the case A described above (i.e., only priority 1, priority 2, priority 3, and priority 7 are considered).

The SLSS referred to in this specification may imply an SLSS block (S-SSB), and the S-SSB may include an SL primary SS (S-PSS), an SL SSS (S-SSS), and an SL broadcast channel (e.g., a physical SL broadcast channel (PSBCH)). In this case, the S-PSS may include a Zadoff-Chu sequence or M-sequence, and the S-SSS may include an M-sequence or gold sequence. Similar to the PSS and SSS in a cellular system, the SL ID may be transmitted through a combination of the S-PSS and the S-SSS or only the S-SSS rather than a combination of the two. The PSBCH may transmit a master information block (MIB) for SL communication similar to a physical broadcast channel (PBCH) of the cellular system.

Herein, a case in which an SL parameter is preconfigured in an SL UE may be applied to a scenario in which the SL UE is located outside the coverage of the base station (i.e., an out-of-coverage scenario). The case in which a parameter is preconfigured in a UE may be interpreted as a case in which a value already stored in the UE when the UE is released is used.

As another example, the parameter pre-configured in the UE may be understood as a value of SL parameter information stored in advance by the SL UE which has previously accessed a base station and acquired the SL parameter information therefrom, through RRC configuration.

As yet another example, the parameter pre-configured in the UE may be understood as a value of SL system information stored in advance by the SL UE which has previously acquired the SL parameter information from a base station although the UE has not accessed the base station.

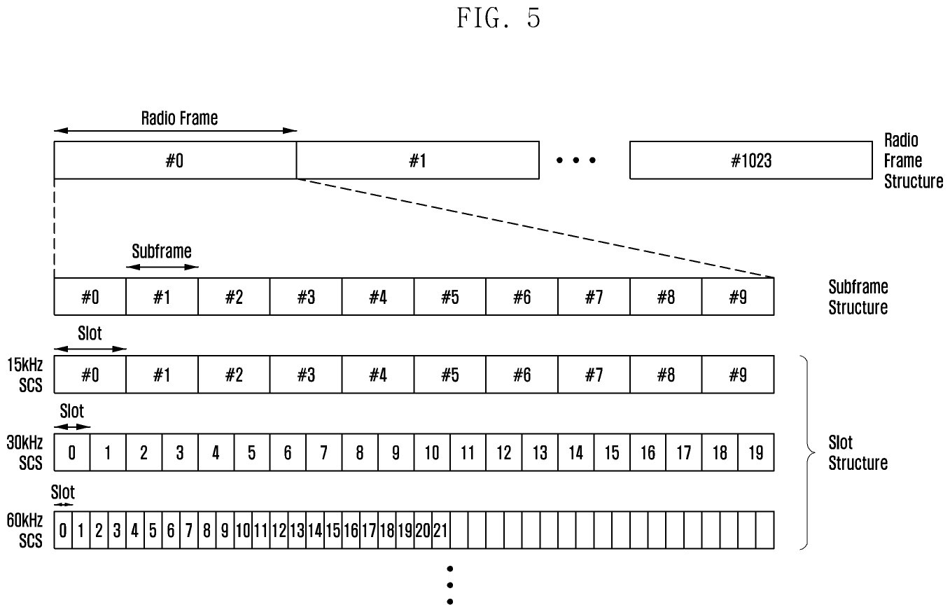

FIG. 5 illustrates a frame structure of an SL system according to an embodiment.

Referring to FIG. 5, the system operates 1024 radio frames, but is not limited thereto. For example, the number of radio frames operated by the system may be configured by a base station or preconfigured, and may be greater than or less than 1024 radio frames.

When an SL UE is located within a coverage of the base station, the SL UE may obtain information about the radio frame through an MIB of a PBCH transmitted by the base station. When the SL UE is located outside the coverage of the base station, information on the radio frame may be preconfigured in the SL UE.

In FIG. 5, the radio frame number and the system frame number may be treated the same. That is, a radio frame number ‘0’ may correspond to a system frame number ‘0’, and a radio frame number ‘1’ may correspond to a system frame number ‘1’. One radio frame may be configured by 10 subframes, and one subframe may have a length of 1 ms on the time axis.

As illustrated in FIG. 5, the number of slots constituting one subframe may differ according to a subcarrier spacing used in NR V2X. For example, when using a subcarrier spacing of 15 kHz in NR V2X communication, one subframe may be identical to one slot. However, when using a subcarrier spacing of 30 kHz and a subcarrier spacing of 60 kHz in NR V2X communication, one subframe may be identical to 2 slots and 4 slots, respectively.

Although not illustrated in FIG. 5, a corresponding number of slots may be applied even when a subcarrier spacing of 120 kHz or higher is used. That is, when the number of slots constituting one subframe is normalized, the number of slots constituting one subframe may increase to 2ⁿ as the subcarrier spacing increases based on a subcarrier spacing of 15 kHz, wherein n may have a value of 0, 1, 2, 3 . . . . (n=0, 1, 2, 3, . . . ).

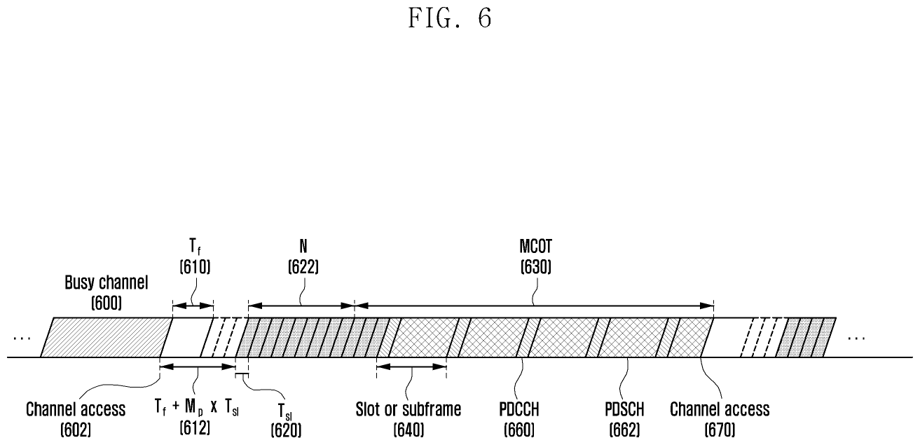

FIG. 6 illustrates a channel access procedure in an unlicensed band in a wireless communication system according to an embodiment. Specifically, FIG. 6 illustrates a base station performing a channel access procedure to occupy an unlicensed band.

Referring to FIG. 6, a base station desiring to transmit a DL signal to an unlicensed band may perform a channel access procedure for an unlicensed band during a minimum time of T_{f}+mₚ×Tₛₗ (e.g., a defer duration 612). T_{f} is an initial defer duration value, which may be used to determine whether a channel is in an idle state. Tₛₗ is a channel access attempt duration, and mₚ is the number of possible channel accesses. If the base station desires to perform the channel access procedure based on channel access priority class 3 (p=3), the size of the defer duration T_{f}+mₚ×Tₛₗ may be configured using m p (m p=3) with respect to the size of the defer duration T_{f}+mₚ×Tₛₗ. Here, the value of T_{f} is fixed as 16 μs (e.g., a duration 610), and the first Ti thereof should be in an idle state. The base station may not perform the channel access procedure during the remaining time (T_{f}-Tₛₗ) after Tₛₗ time among the T_{f} time. Even when the base station has performed the channel access procedure during the remaining time (T_{f}-Tₛₗ), the channel access may not occur. In other words, the time (T_{f}-Tₛₗ) corresponds to a time for which the base station defers to perform the channel access.

In case that the unlicensed band is in an idle state during the entire time of the (mₚ×Tₛₗ) time, N=N−1. N may be selected as a random integer value among values between 0 and the value of the contention window (CWp) at the time of performing the channel access procedure.

In the case of channel access priority class 3, the minimum and maximum contention window values are 15 and 63, respectively. When it is determined that the unlicensed band is in an idle state in the defer duration and the additional duration in which the channel access procedure is performed, the base station may transmit a signal through the unlicensed band during T_{mcot,p} time (8 ms).

Herein, embodiments are described based on DL channel access priority classes for convenience of explanation. In the case of a UL, the same channel access priority class of Table 1 may be used, or a separate channel access priority class for UL signal transmission may be used.

TABLE 1

| Channel | | | | | |
|---|---|---|---|---|---|
| Access | | | | | allowed |
| Priority | | | | | CWₚ |
| Class (p) | mₚ | CW_{min, p} | CW_{max, p} | T_{mcot, p} | sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, |
| | | | | | 255, 511, 1023} |

The initial contention window value (CWₚ) is the minimum contention window value (CW_{min,p}). After selecting the value of N, the base station may perform the channel access procedure in the Ti duration (e.g., the slot duration 620), and when the unlicensed band is determined to be in an idle state through the channel access procedure performed in the Ti duration, the base station may change the value of N to the value of (N−1) and may transmit, when N corresponds to 0 (N=0), a signal during a maximum T_{mcot,p} time (e.g., the maximum occupancy time 630) through the unlicensed band.

In case that the unlicensed band determined through the channel access procedure at time Tₛₗ is not in an idle state, the base station may perform the channel access procedure again without changing the value of N.

The size of the value of the contention window (CWₚ) may be maintained or changed as described below.

When one or more UEs receive DL data transmitted through a DL data channel by using a reference subframe, reference slot, or reference transmit interval (e.g., a reference transmission time interval (TTI)) and when the UEs transmit or report the results (i.e., ACK/NACK) of receiving the DL data received by using the reference subframe, reference slot, the reference transmit interval to the base station, the size of the value of the contention window CWₚ may be maintained or changed according to the ratio (Z) of NACKs among the results. Here, the reference subframe, reference slot, or reference transmit interval may be determined as the timepoint at which the base station initiates the channel access procedure, the timepoint at which the base station selects the value of N in order to perform the channel access procedure, or the DL signal transmission interval (or maximum COT (MCOT)) transmitted most recently by the base station through the unlicensed band immediately before the two timepoints.

Referring again to FIG. 6, a base station may attempt channel access to occupy an unlicensed band. The reference slot, reference subframe, or reference TTI may be defined as the timepoint 602 or 670 when the base station initiates the channel access procedure, the timepoint when the base station selects the value of N 622 in order to perform the channel access procedure, or the first slot (or the start slot starting the channel occupancy duration), subframe, or transmit TTI 640 of the DL signal transmission interval (i.e., the COT, hereinafter interchangeably used with MCOT)) 630 transmitted most recently by the base station through the unlicensed band immediately before the same. For convenience of explanation, the reference slot, reference subframe, or reference TTI may be expressed as a reference slot below. Specifically, the reference slot may be defined as one or more consecutive slots, including the first slot in which signals are transmitted among all slots of the DL signal transmission interval 630.

In addition, according to an embodiment, in case that the DL signal transmission interval starts after the first symbol of the slot, the slot in which the DL signal transmission starts and the slot following the slot may be defined as the reference slot.

In case that one or more UEs receive DL data transmitted through a DL data channel of such a reference slot, and if the ratio of NACKs among the results of receiving the DL data, which are transmitted or reported to the base station by the UEs, is greater than or equal to Z, then the base station may determine that the value or size of the contention window used for the channel access procedure 670 of the corresponding base station is the next contention window larger than the contention window used for the previous channel access procedure 602. In other words, the base station may increase the size of contention window used in the channel access procedure 602. The base station may perform the next channel access procedure 670 by selecting a value of N 622 in the range defined according to the increased contention window.

In case that the base station is unable to receive the result of receiving the DL data channel transmitted through the reference slot of the COT 630, e.g., if the time interval between the reference slot and the timepoint 670 at which the base station initiates the channel access procedure is less than or equal to n slots or symbols (that is, the base station initiates the channel access procedure before the time at which UEs can report the result of receiving the DL data channel transmitted by the reference slot), the first slot of the most recent COT transmitted before the COT 630 becomes the reference slot.

If the base station cannot receive, from UEs, the results of receiving DL data transmitted through the reference slot 640 at the timepoint 670 at which the base station initiates the channel access procedure, at the timepoint at which the base station selects the value of N in order to perform the channel access procedure, or immediately before the same, the base station may determine a contention window using the result of receiving DL data by the UE for the reference slot of the most recently transmitted COT, among the results of receiving the DL data channel already received from UEs.

In addition, the base station may determine the size of the contention window used for the channel access procedure 670 by using the results of receiving DL data received from the UEs with regard to DL data transmitted through the DL data channel in the reference slot.

For example, the base station has transmitted a DL signal through a channel access procedure (e.g., CWₚ=15) configured based on channel access priority class 3 (p=3), and when at least 80% of the results of receiving, by the UE, DL data transmitted to the UEs through the DL data channel in the reference slot, among DL signals transmitted through the unlicensed band, are determined as NACKs, the base station may increase the contention window from the initial value (CWₚ=15) to the next contention window value (CWₚ=31). The value of 80% is illustrative, and many variations are possible.

In case that it is not determined that at least 80% of the result of receiving by the UE are NACKs, the base station may maintain the existing value of the contention window or change the same to the initial value of the contention window. The contention window change may be commonly applied to all channel access priority classes or only to the channel access priority class used for the channel access procedure. A method for determining the value of Z, among results of receiving DL data, which have been transmitted or reported from the UEs to the base station with regard to DL data transmitted through the DL data channel, in the reference slot used to determine the contention window size change, may be performed as described below.

In case that the base station transmits at least one codeword (CW) or TB to at least one UE in a reference slot, the base station may determine the value of Z from the ratio of NACKS among receiving results transmitted or reported by the UEs with regard to the TB received by the UE using the reference slot. For example, if two CWs or two TBs are transmitted to one UE by using the reference slot, the results of receiving DL data signals related to the two TBs are transmitted or reported from the UE to the base station.

In case that the ratio (Z) of NACKs among the two receiving results is greater than or equal to a threshold value (e.g., Z=80%) defined in advance or configured between the base station and the UE, the base station may increase or change the contention window size.

In case that the UE bundles results of receiving DL data regarding at least one slot (e.g., M slots), including the reference slot, and then transmits or reports the same to the base station, the base station may determine that the UE has transmitted M receiving results. In addition, the base station may determine the value of Z based on the ratio of NACKs among the M receiving results and change, maintain, or initialize the contention window size.

In case that the reference slot is the second slot among two slots included in one subframe, or in case that a DL signal is transmitted from a symbol after the first symbol in the reference slot, the reference slot and the next slot are referred to as the reference slot, and the value of Z may be determined based on the ratio of NACKs among receiving results transmitted or reported from the UE to the base station with regard to DL data received by using the reference slot.

Further, in case that scheduling information regarding a DL data channel or DL control information is transmitted through a cell or a frequency band on which a DL data channel is transmitted, or in case that that scheduling information regarding a DL data channel or DL control information is transmitted through an unlicensed band, but is transmitted through a cell or a frequency band different from the cell or a frequency band on which the DL data channel is transmitted, or in case that it is determined that the result of receiving DL data transmitted by the UE is at least one of discontinuous transmission (DTX), NACK/DTX, or any state, the base station may determine the value of Z by determining the receiving result of UE as a NACK.

In addition, in case that scheduling information regarding the DL data channel is transmitted by the base station or DL control information is transmitted through a licensed band, and when it is determined that the result of receiving DL data transmitted by the UE is at least one of discontinuous transmission (DTX), NACK/DTX, or any state, the base station may not reflect the receiving result of the UE included in the reference value Z of the contention window change. That is, the base station may determine the value of Z without considering the receiving result of the UE.

In addition, in case that the base station transmits scheduling information regarding the DL data channel or DL control information through a licensed band, and when the base station has not actually transmitted DL data (no transmission) among results of receiving DL data related to the reference slot, which are transmitted or reported from the UE to the base station, the base station may determine the value of Z without considering the receiving results transmitted or reported by the UE with regard to DL data.

In addition, in 5G NR, it may be possible to determine a time duration as a reference by considering a reference duration instead of a reference slot. The reference duration may correspond to a duration from the timepoint when the COT starts to the last timepoint of the first slot in which at least one unicast physical DL shared channel (PDSCH) is transmitted and received without puncturing in a scheduled resource. Alternatively, the reference duration may correspond to a duration from when the COT starts to the last time of a first transmission burst including at least one unicast PDSCH without puncturing in a scheduled resource.

Further, in the case of the TB unit transmission scheme, when a HARQ-ACK value for at least one unicast PDSCH within the reference duration is ACK, the UE may determine the contention window size as the minimum value, and otherwise, the contention window size value may be possible to further increase by 1.

In the case of a CBG unit transmission scheme, when the ratio of ACK among HARQ-ACK information values for PDSCHs in the reference duration is at least 10%, the UE may determine the contention window size as the minimum value, and otherwise, the contention window size may be possible to further increase the value by 1.

In the case of DL, the contention window size adjustment of the base station may be possible by using CBG-based HARQ-ACK information, non-unicast data information, non-slot-unit data transmission, or no transmission event in which data is scheduled but not actually transmitted. For example, when transmission of CBG-based HARQ-ACK information is configured, the value of Z may be determined by individually considering whether ACK or NACK of HARQ-ACK information for each CBG is transmitted.

In the case of non-unicast data information, since there is no transmission of HARQ-ACK information from the UE, when determining ACK or NACK information for the non-unicast data information, the base station may always determine the HARQ-ACK information as ACK or NACK, or may enable determination of the HARQ-ACK information as neither ACK nor NACK.

Not determining ACK/NACK information is understood as meaning that the feedback information is not taken into account in determining the value of Z since the feedback information is not available for the corresponding unicast data information.

In the case of a UL, the contention window size adjustment of the UE is similar to the contention window size adjustment of the base station in the case of a DL. However, at the time of determining the reference duration, a unicast physical UL shared channel (PUSCH) is considered rather than the unicast PDSCH. Further, the determination of HARQ-ACK information can be made implicitly using HARQ-ACK information explicitly indicated through the base station or through a new data indicator (NDI) included in DL control information (DCI) for scheduling a PUSCH. For example, when the NDI value of 1 bit for a specific HARQ process number is toggled differently from the previous one, the UE determines that transmission of the previously transmitted PUS CH was successful (i.e., ACK) and when the NDI value is not toggled, the UE may determine that transmission of the transmitted PUSCH has failed (i.e., NACK). Toggling refers that the NDI value being changed from 1 to 0 or 0 to 1, and not toggling refers to the NDI value being maintained at 1 or 0.

In case that HARQ-ACK information for the previously transmitted PUSCH is available within the determined reference duration and when the HARQ-ACK information is an ACK, the UE determines the contention window size as the minimum value. However, if the HARQ-ACK information is a NACK, the UE further increases the value of the contention window size by 1.

HARQ-ACK information for a previously transmitted PUSCH within the determined reference duration may not always be available. Therefore, in this case, when the PUSCH transmission corresponds to the initial transmission or the PUSCH transmitted during the reference duration, the UE applies the same contention window size as the previously used contention window size. However, when the PUSCH transmission is retransmission, the UE increases the value of the contention block size by 1.

The channel access procedure in the unlicensed band may be classified according to whether the channel access procedure start time of a communication device is fixed (frame-based equipment (FBE)) or variable (load-based equipment (LBE)).

In addition to the start time of the channel access procedure, the communication device may be determined as an FBE device or an LBE device depending on whether a transmit/receive structure of the communication device has one period or no period. Here, the channel access procedure start time being fixed may be understood as meaning that the channel access procedure of the communication device may be periodically initiated according to a predefined period or a period declared or configured by the communication device.

As another example, the channel access procedure start time being fixed may be understood as meaning that the transmit/receive structure of the communication device has one period.

The channel access procedure start time being variable may be understood as that the channel access procedure start time of the communication device is possible at any time when the communication device is to transmit a signal through an unlicensed band.

As another example, the channel access procedure start time being variable may be understood as that the transmit/receive structure of the communication device does not have a single period and may be determined as needed.

The channel access procedure in an unlicensed band may include a procedure in which the communication device measures the strength of a signal received through the unlicensed band for a fixed time or a time calculated according to a predefined rule (e.g., a time calculated through at least one random value selected by the base station or the UE), and compares the measured signal strength with a predefined threshold or a threshold which is calculated according to at least one variable of a channel bandwidth, a signal bandwidth through which a signal to be transmitted is transmitted, and/or an intensity of transmission power, so as to determine whether the unlicensed band corresponds to an idle state.

For example, the communication device may measure the strength of a received signal for Xμs (e.g., 25 μs) immediately before the timepoint at which the signal is to be transmitted, and when the measured signal strength is less than a predefined or calculated threshold value T (e.g., −72 dBm), the communication device may determine that the unlicensed band is in an idle state and transmit the configured signal. The maximum time for which continuous signal transmission is possible after the channel access procedure may be limited according to the MCOT defined for each country, region, and frequency band according to each unlicensed band.

In addition, the above-described maximum time may be limited according to the type of communication device (e.g., a base station or a UE, or a master device or a slave device). For example, in Japan, in a 5 GHz unlicensed band, a base station or UE may occupy a channel without performing an additional channel access procedure for up to 4 ms with respect to an unlicensed band, which is determined to be in an idle state after performing a channel access procedure, and may transmit a signal.

More specifically, when a base station or UE wants to transmit a DL or UL signal in an unlicensed band, channel access procedures that the base station or UE may perform may be classified into at least the following types.
Type 1: Transmission of UL/DL signals after performing a channel access procedure for a variable period of time
Type 2: Transmission of UL/DL signals after performing a channel access procedure for a fixed period of time
Type 3: Transmission of DL or UL signals without performing a channel access procedure

A transmission device (e.g., a base station or a UE) that wants to perform signal transmission through an unlicensed band may determine a method (or type) of a channel access procedure according to the type of signal to be transmitted.

In 3GPP, a listen before talk (LBT) procedure, which is a channel access method, may be divided into four categories. The four categories may include a first category, which is a scheme of not performing LBT, a second category, which is a scheme of performing LBT without random backoff, a third category, which is a scheme of performing LBT through random backoff in a fixed-size contention window, and a fourth category, which is a scheme of performing LBT through random backoff in a variable-sized contention window. According to an embodiment, it may be understood as that the third and fourth categories correspond to type 1, the second category corresponds to type 2, and the first category corresponds to type 3.

The second category or type 2 in which the channel access procedure is performed during a fixed time may be classified as one or more types according to a fixed time for performing the channel access procedure. For example, Type 2 may be classified to a type that performs the channel access procedure for Alas fixed time (e.g., 25 μs) (Type 2-1) and a type that performs the channel access procedure for B μs fixed time (e.g., 16 μs) (Type 2-2).

Although the above description has mainly been made for a DL in which a base station transmits a signal to a UE or a UL in which a UE transmits a signal to a base station, the description above may be sufficiently applied to an SL in which a UE transmits a signal to another UE.

Hereinafter, in the disclosure, for convenience of explanation, a transmission device is assumed to be a base station or a UE, and the transmission device and the base station may be used interchangeably. In addition, SL may be assumed instead of DL, and in this case, the base station may be replaced by the UE and applied.

For example, when the base station is to transmit a DL signal including a DL data channel through an unlicensed band, the base station may perform a type 1 channel access procedure. In addition, when the base station is to transmit a DL signal that does not include a DL data channel through an unlicensed band, e.g., to transmit an SS or a DL control channel, the base station may perform a type 2 channel access procedure and then transmit a DL signal.

The channel access procedure scheme may be determined according to the transmission length of a signal to be transmitted through the unlicensed band or the length of time or interval used by occupying the unlicensed band. In general, according to the type 1 scheme, a channel access procedure may be performed for a longer time than that of the type 2 scheme. Accordingly, when the communication device is to transmit a signal during a short time interval or a period of time equal to or less than a reference time (e.g., Xms or Y symbol), the type 2 channel access procedure may be performed. On the other hand, when the communication device is to transmit a signal for a longer time interval or a period of time exceeding a reference time (e.g., Xms or Y symbol) or equal to or longer than of the reference time, the type 1 channel access procedure may be performed. That is, different types of channel access procedures may be performed according to a time of the unlicensed band use.

In case that the transmission device performs the type 1 channel access procedure according to at least one of the above criteria, the transmission device that wants to transmit a signal through the unlicensed band may determine a channel access priority class (or channel access priority) according to a quality of service class identifiers (QCI) of the signal to be transmitted through the unlicensed band, and may perform the channel access procedure for the determined channel access priority class by using at least one value among the predefined configuration values as shown in Table 1 above.

As shown above, Table 1 shows a mapping relationship between channel access priority classes and QCI. The mapping relationship between channel access priority classes and QCI in Table 1 is only an example, however, and the disclosure is not limited thereto.

For example, QCI 1, 2, and 4 refer to the QCI values for services, such as conversational voice, conversational video (e.g., live streaming), and non-conversational video (e.g., buffered streaming), respectively.

Alternatively, the type of performing the channel access procedure may be different depending on whether the transmission device supports LBE or FBE. For example, in the case of a transmission device supporting LBE, it is possible to perform at least one channel access method of types 1 to 3, whereas in the case of a transmission device supporting FBE, it is possible to perform only a channel access method of type 2.

Alternatively, it may be possible for the transmission device to apply different types of channel access methods according to specific circumstances. For example, it may be possible for a transmission device to use a type 1 channel access method to initiate channel occupation (e.g., MCOT).

As another example, in case that after the transmission device occupies the channel, different transmission bursts exist within the channel occupation duration and a gap between these bursts is Xμs (e.g., 16 μs) or more, the transmission device may use the type 2 channel access method before transmitting a new transmission burst.

As yet another example, in case that after the transmission device occupies the channel, a gap between different transmission bursts within the channel occupation duration is Xμs (e.g., 16 μs) or less, and the total length of the second transmission burst is Yμs (e.g., 584 μs) or less, the transmission device may use the type 3 channel access method before transmitting the second transmission burst. The transmission burst may be at least one of an SS of DL, UL, or SL, a control channel, or a data channel, or a combination thereof. The transmission burst may refer to a bundle of channels in which the transport channels are continuously concatenated in terms of time resources.

Hereinafter, in the description, a communication device and a UE are used as the same concept, and may be used interchangeably. The transmission node refers to a communication device that transmits data, and the reception node refers to a communication device that receives data. In addition, the transmission node may refer to a communication device that occupies a channel for data transmission, and the reception node may refer to a communication device which, in the case of transmitting HARQ-ACK feedback according to reception of data, transmits the corresponding feedback to the transmission node.

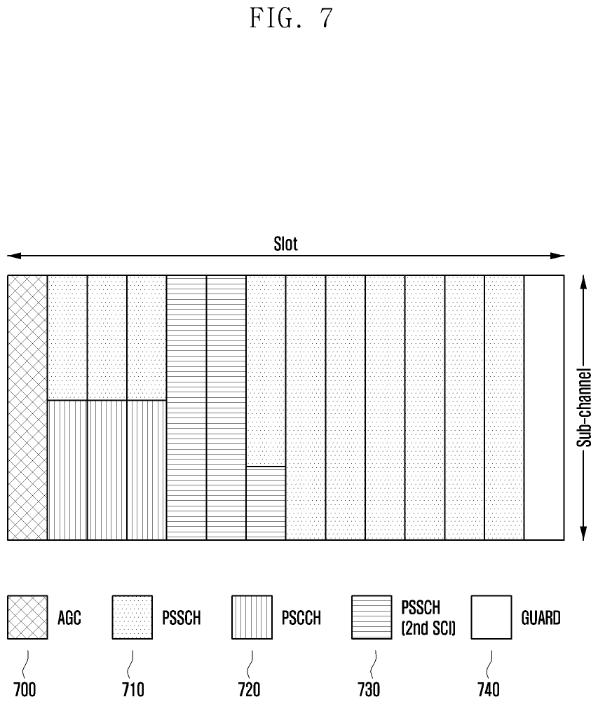

FIG. 7 illustrates an SL channel according to an embodiment.

Referring to FIG. 7, time resources for SL data transmission and reception may include an adaptive gain controller (AGC) symbol 700 for antenna gain control, three physical SL control channel (PSCCH) symbols 720, 10 physical SL shared channel (PSSCH) symbols 710, and a guard symbol 740. However, the disclosure is not limited by this example, and it may be possible to have different numbers of symbols for each channel.

The PSSCH may include data information and 2nd SL control information (2nd SCI) 730 indicated by 1st SL control information (1st SCI) included in the PSCCH 720, and may be possible to be configured only with PSSCH without 2nd SCI.

The first symbol is an AGC symbol and is configured by the same information as that of the second symbol. The AGC symbol is used because there may be multiple transmission nodes to transmit, the distances between the transmission nodes and a reception node are likely different, and the transmission power may also be different. Accordingly, from the point of view of the reception node, received power strength may differ depending on which transmission node performs SL communication. Therefore, since the reception node likely needs some time to correct this difference, the first symbol is allocated as an AGC symbol for the difference correction.

The PSCCH is a physical channel used to deliver SCI and may be transmitted in 12, 15, 20, or 25 physical resource blocks (PRBs) in one subchannel, and the value may be configured by a higher layer signal. Although the number of symbols of PSCCH is 3 symbols in FIG. 7, the PSCCH may include 1 symbol or 2 symbols, and this value may be configured by a higher layer signal. Mapping of control information included in the PSCCH is performed from the lowest PRB index first.

The PSSCH is a physical channel used to deliver SL data information (e.g., a TB), and 2nd SCI information may be mapped to a first demodulation reference signal (DMRS) symbol transmitted from the PSSCH. The PSSCH may be transmitted in units of one subchannel, and the size of one subchannel may be 10, 12, 15, 20, 25, 50, or 100 PRBs, and from 1 to a maximum of 27 sub-channels may exist within one SL BWP. In addition, when a PSSCH and a PSCCH have the same PRB, it may be possible that all of the second, third, and fourth symbols in FIG. 7 are configured by PSCCHs. Although not separately indicated in FIG. 7, a DMRS for decoding the PSSCH may be included in the 5th symbol.

In addition, although not separately indicated in FIG. 7, a PSFCH, instead of a PSSCH, may exist in the 12th and 13th symbols, the PSFCH delivering HARQ-ACK information for the PSSCH. In case that the PSFCH exists, the 10th symbol may be a guard symbol. The guard symbol may exist as one symbol because a separate switching time is required for the UE having received the PSSCH to transmit the PSFCH. In addition, the 14th symbol is a guard symbol to account for switching time that is also required. For example, a time for switching between transmission and reception may be required for at least one of a case in which a UE that is transmitting a PSCCH and a PSSCH in slot n receives the PSCCH and the PSSCH from another UE in slot (n+1), and a case in which a UE receiving a PSCCH and a PSSCH in slot n transmits the PSCCH and the PSSCH to another UE in slot (n+1). A transmission format by which the UE performs transmission in the PSFCH may be the same as PUCCH format 0 defined in the 3GPP Rel-15 NR standard, and may be configured in the form in which HARQ-ACK information is repeatedly transmitted over one PRB and two symbols based on the Zadoff-Chu sequence. As described above, the first symbol of the two symbols of the PSFCH may be used for AGC.

In the description above, the first control information provides information related to resource allocation, and may include at least one of, e.g., frequency resource information, time resource information, a DMRS pattern, a second control information format, a size of resource to which the second control information is allocated, the number of DMRS ports, a modulation and coding scheme (MCS), and PSFCH transmission or not. Among the above examples, the DMRS pattern is a field notifying of information on which time and frequency resources the DMRS for PSSCH reception is allocated to, the second control information format is a field notifying of configuration information and the size of the second control information transmitted to the PSSCH, the size of resource to which the second control information is allocated is a field notifying the PSSCH of the amount of resources to which the second control information is allocated, the number of DMRS ports is a field notifying of information indicating the number of ports through which the DMRS is transmitted, and the MCS is a field notifying of PSSCH encoding information.

The second control information provides UE-specific or specific information related to the corresponding service, and may include at least one of, e.g., a HARQ process number, NDI, a redundancy version (RV), a source ID, a destination ID, a HARQ feedback enabled/disabled indicator, a cast type indicator, and a channel state information (CSI) request field. In the example above, the NDI is a field configured by 1 bit and indicating whether a currently transmitted TB of a PSSCH is a retransmission or an initial transmission, and is a field that determines the TB as an initial (or new) transmission when toggling occurs (changes from 1 to 0, or from 0 to 1), and determines the TB as a retransmission when toggling does not occur. The RV is a field indicating the starting point of an encoded bit when PSSCH is encoded based on LDPC coding, the source ID is the ID of a UE having transmitted the PSSCH, the destination ID is the ID of a UE receiving the PSSCH, the HARQ feedback enabled/disabled indicator is an indicator field indicating whether or not HARQ feedback transmission occurs with respect to the corresponding PSSCH transmission, the cast type indicator is a field indicating whether the currently transmitted PSSCH is unicast, group cast, or broadcast, and the CSI request field is a field including an indication by which the reception UE reports the measured CSI information to the transmission UE.

A time resource for SL communication may be configured to have a value of one of 7 to 14 symbols within one slot configured by 14 symbols for each SL BWP.

A structure for transmitting and receiving a control channel and a data channel for SL communication has been described with reference to FIG. 7. This structure may also be applied to unlicensed bands, but there may be a problem of compliance with specific conditions due to different regulations and restrictions in each country or continent. One of the specific conditions is an occupied channel bandwidth (OCB), the definition of which is that the frequency band containing 99% of the transmission signal power should be included in 80% to 100% of the nominal channel bandwidth in which the transmission signal is performed. For example, in an unlicensed band having the size of a channel frequency band of 20 MHz, it may be seen that the UE satisfies the above regulation only when it unconditionally performs transmission of at least 14 MHz. The value of 80% is just an example and may be a different value for each country.

However, in the case of a UE, the use of a wide bandwidth may cause lowering the transmission power efficiency in order to reduce the transmission distance, which results in reducing the communication radius in the unlicensed band. Therefore, the bandwidth to which the signal including 80% to 100% of the channel frequency band is allocated does not need to be allocated consecutively, and when at least one PRB per specific M PRBs is allocated in terms of frequency, the above regulation can be satisfied. Accordingly, an interlace method for resource allocation may be used as a method for allocating the information at regular intervals, rather than a method for allocating control or data information consecutively in terms of frequency. For example, an interlace block m may have a value of 0 to M−1, the value of m may indicate that a resource is actually allocated to a common resource block {m, M+m, 2M+m, 3M+m, . . . }, and the value of M may have a different value according to a subcarrier spacing. The interlace method does not need to be satisfied in all countries and continents that use unlicensed bands, may be used only in countries and continents that should satisfy some relevant regulations, and the configuration may be configured by a higher layer signal.

However, in the case of side link communication, communication support should be enabled in an area outside the coverage without configuring a separate base station, and thus SL communication may be supported in an area requiring the relevant regulation by considering GPS information, pre-determined location information, or the interlace structure at the time of manufacturing the UE.

Considering whether the OCB regulation is satisfied with the SL channel structure described in FIG. 7, in the case of PSCCH and/or PSSCH consisting of 20 PRBs, transmission of a control channel and/or a data channel is difficult in a system having a channel frequency band consisting of 100 PRBs. Since the 100 PRBs correspond to the number of possible PRBs in a 20 MHz band having a subcarrier spacing of 15 kHz, it is difficult to freely utilize the structure of FIG. 7 in the above situation. In FIG. 7, configuration of a PSCCH and/or a PSSCH consisting of 100 PRBs is enabled, and thus it is possible to transmit a control channel and/or a data channel while meeting the OCB requirements in a limited manner. However, since frequency division multiplexing (FDM) with another UE is not allowed, only one UE may perform data transmission/reception at a specific moment.

Below, a higher layer signal may include at least one of RRC signaling between a base station and a UE or PC5-RRC signaling between UEs.

There may be several methods for improving communication reliability in SL communication. For example, the methods may include repeated transmission, transmission of a low code rate, or determining whether data reception is successful at the reception node through a feedback channel Among these methods, introducing a feedback channel may be the most efficient method to increase reliability because repeated transmission and low code rate transmission may increase communication reliability. However, there is still a possibility of unnecessarily consuming a lot of SL radio resources. Accordingly, an SL UE operating in a licensed band may receive feedback information about the transmitted data information and accordingly, may determine whether to transmit other data or retransmit the previously transmitted data.

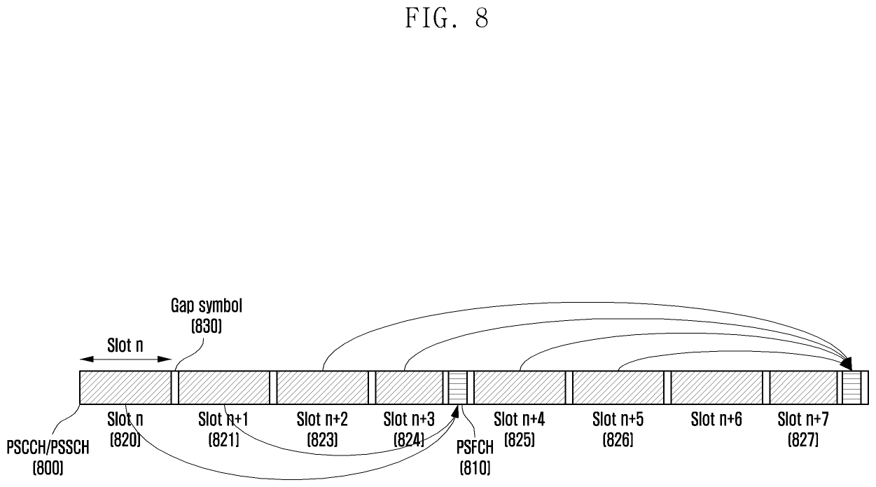

FIG. 8 illustrates a relationship between a control/data channel and a feedback channel of an SL UE operating in a licensed band according to an embodiment.

Referring to FIG. 8, it is assumed that a PSFCH channel 810 exists in slots (n+3) 824 and (n+7) 827 by considering that the PSFCH exists every 4 slots. However, the PSFCH may exist every 2 slots or 1 slot. In addition, although it is assumed that the PSFCH channel is regularly allocated in FIG. 8, the PSFCH channel may be allocated irregularly.

A slot in which a PSCCH/PSSCH 800 is transmitted and received and a slot in which a PSFCH channel including HARQ feedback information regarding thereto is transmitted and received may be mapped to each other. For example, when an SL UE-A transmits a PSCCH/PSSCH in slot n 820 to slot (n+1) 821, the SL UE-1 having received the PSCCH/PSSCH transmits HARQ feedback regarding thereto through the PSFCH existing at slot (n+3) 824. Although HARQ information about the PSCCH/PSSCH transmitted and received in each slot is transmitted and received through the PSFCH 810 of slot (n+3) 824, the channels including each HARQ feedback information may be classified as different frequency or different time (symbols) or different code resources.

In case that the SL UE-A transmits PSCCH/PSSCH in slot (n+2) (823) and slot (n+3) (824), the SL UE-1 having received the PSCCH/PSSCH transmits HARQ feedback regarding thereto in slot (n+7) 827, rather than slot (n+3) 824. The transmission is performed in slot (n+7) 827 because SL UE-1 requires processing time for demodulating and decoding the PSCCH/PSSCH transmitted by the SL UE-A in slot (n+2) and slot (n+3) and a processing time for generating HARQ feedback information regarding thereto. Therefore, since it is difficult for the SL UE-1 to transmit HARQ feedback information through a PSFCH in slot (n+3), HARQ feedback information is transmitted in slot (n+7). Therefore, the PSCCH/PSSCH for the PSFCH transmitted in slot (n+7) (827) may be transmitted and received through slots (n+2) 823, (n+3) 824, (n+4) 825, and (n+5) 826.

Although not illustrated in FIG. 8, the PSFCH including HARQ feedback information for the PSSCH/PSCCH transmitted and received in slot (n+6) and slot (n+7) 827 may be transmitted and received in slot (n+11). Assuming that the slot period in which the PSFCH exists is “m” and the PSCCH/PSSCH should be transmitted and received before at least k slots to include HARQ feedback information in the PSFCH.

FIG. 8 shows the case in which m=4 and k=2. However, this is just an example, and it may be sufficiently possible that values other than m=4 and k=2 are applied. In FIG. 8, the PSCCH/PSSCH structure may follow the form illustrated in FIG. 7.

In FIG. 8, a gap symbol 830 should exist before transmitting the PSCCH/PSSCH or transmitting the PSFCH to an SL UE. The size of the gap symbol may be 1 symbol, and the gap symbol exists to ensure sufficient processing time for the SL UE to switch from a reception mode to a transmission mode.

In case that one SL UE transmits PSCCH/PSSCH in both slot n and slot (n+1), or receives both PSCCH/PSSCH, separate processing time for the switching may not be required between slot n and slot (n+1). However, since it is difficult to predict when and which SL UE transmits or receives data due to the nature of SL communication, the processing time for the switching is considered and the case where the gap symbol as shown in FIG. 8 exists has been considered.

In case that the structure of FIG. 8 is applied to an unlicensed band, the SL UE-A that is to continuously transmit SL data in slot n 820 and slot (n+1) 821 has a possibility of performing additional channel access due to the gap symbol 830 between slot n 820 and slot (n+1) 821. Since the length of 1 symbol based on a 15 kHz subcarrier is approximately 71 μs, and a gap between consecutive transmission intervals is 25 μs or more in the unlicensed band, a UE which is to transmit PSCCH/PSSCH in slot (n+1) 921 should perform a first type channel access (channel access during variable interval) and thus, there is a possibility that the PSCCH/PSSCH may not be transmitted in slot (n+1) 821. Further, in case that the length of one symbol based on a 30 kHz subcarrier is approximately 36 μs, and the gap between consecutive transmission intervals in the unlicensed band is 25 μs or more, since the first type channel access (channel access during the variable interval) should be performed, there is a possibility that a UE, which is to transmit the PSCCH/PSSCH in slot (n+1) 821, may not transmit the PSCCH/PSSCH in slot (n+1) 821.

In addition, since the length of one symbol based on a 60 kHz subcarrier is approximately 18 μs, and the gap between successive transmission intervals is 25 μs or less in the unlicensed band, the UE that is to transmit the PSCCH/PSSCH in slot (n+1) 821 performs a second type channel access (channel access during a fixed interval) or third type channel access (channel access not performed), and thus, it is likely that the PSCCH/PSSCH may be transmitted in slot (n+1) 821.

The criterion for determining which type of channel access procedure should be performed among the second type channel access (channel access during a fixed interval) or the third type channel access (channel access not performed) may be the transmission length of the PSCCH/PSSCH transmitted in slot (n+1) 821 (and subsequent slots). For example, when the transmission length is 584 μs or more, the UE may perform a second type channel access (channel access during a fixed interval), and when the transmission length is 584 μs or less, the UE may perform a third type channel access (channel access not performed). The value of 584 μs is just an example and may be replaced by another value, and the corresponding value may be configured by the base station or pre-configured. In addition, configuration values may be different in the licensed band and the unlicensed band.

In the case of 15 kHz and 30 kHz subcarriers having the symbol length longer than that of a 60 kHz subcarrier, various methods may be used to solve the problem caused by the gap of 1 symbol illustrated in FIG. 8.

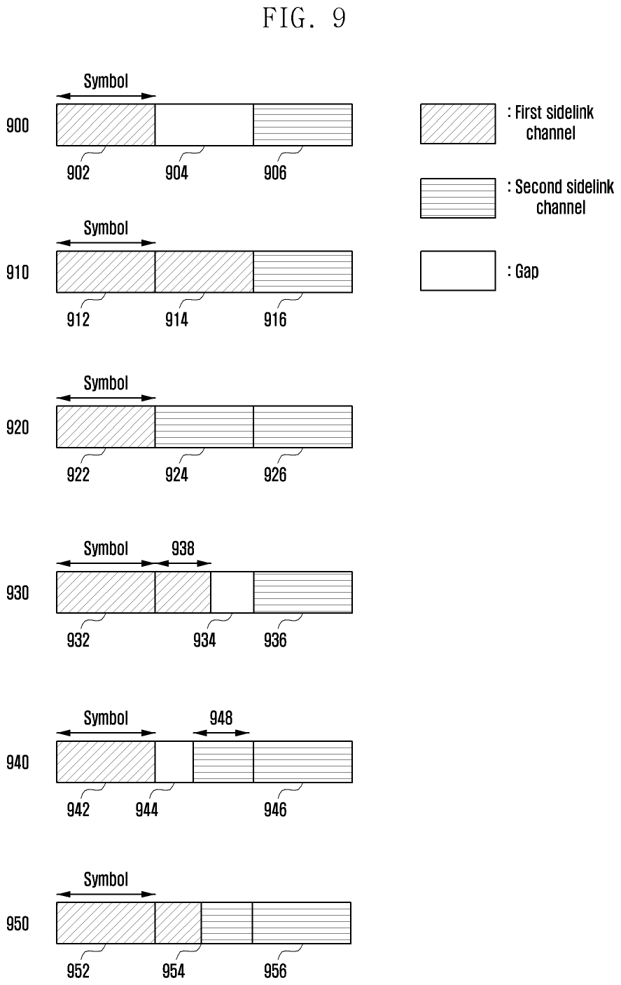

FIG. 9 illustrates a method for configuring a gap duration of 25 μs or less in an unlicensed band according to an embodiment.

Referring to FIG. 9, reference numerals 902, 912, 922, 932, 942, and 952 indicate a first SL channel and may be at least one of a PSCCH, a PSSCH, and a PSFCH, and although the first SL channel is illustrated as the length of one symbol, in the case of a channel consisting of two or more symbols, only the last symbol may be shown.

Reference numerals 906, 916, 926, 936, 946, and 956 may indicate a second SL channel and may be at least one of a PSCCH, a PSSCH, and a PSFCH, and although the second SL channel is shown as the length of one symbol, in the case of a channel consisting of two or more symbols, only the first symbol may be shown. Each symbol indicated by reference numerals 900, 910, 920, 930, 940, and 950 may exist in the same slot or subframe, or at least some of the symbols may exist in different slots or subframes.

Hereinafter, methods for supporting the second type channel access method or the third type channel access method between the first SL channel and the second SL channel will be described. An SL UE operating in an unlicensed band may be able to operate by applying at least one of the following methods or some combination thereof. The method below may be performed by the SL transmission UE, and the SL reception UE may also operate under the understanding that the same method is applied.

Method 1-1: Using Widely Spaced Subcarriers.

Reference numeral 900 shows an example of a gap symbol 904 in which no control information or data information is transmitted between a first SL channel and a second SL channel. As described above, since the length of a gap symbol is less than in a subcarrier spacing of 60 kHz or higher, the SL control and data channel transmission/reception structure shown in FIG. 8 may be used. According to method 1-1, an SL UE operating in an unlicensed band may operate using a subcarrier of 60 kHz or higher.

Method 1-2: Copying the Last Symbol of the First SL Channel to the Gap Symbol.

Reference numeral 910 shows a structure in which the first SL channel (or the last symbol of the first SL channel) 912 is copied and repeatedly transmitted as indicated by reference numeral 914. Accordingly, it may be possible to eliminate a gap between the first SL channel and the second SL channel.

Method 1-3: Copying the First Symbol of the Second SL Channel to the Gap Symbol.

Reference numeral 920 shows a structure in which the second SL channel (or the first symbol of the second SL channel) 926 is copied and repeatedly transmitted as indicated by reference numeral 924. Accordingly, it may be possible to eliminate a gap between the first SL channel and the second SL channel.

Method 1-4: Extending a CP of the Last Symbol of the First SL Channel so that the Gap Symbol has a Duration of 25μs.

Reference numeral 930 indicates a part of the first SL channel 932 which is copied and mapped to a part of a symbol as indicated by reference numeral 938. In this case, the length of the part indicated by reference numeral 938 may have a value such that the length of a gap 934 is 25 μs or less, and specifically, the length of the part indicated by reference numeral 938 may have a value of (the length of 1 symbol-25 μs) or more. Copying a part of the first SL channel may mean that a part corresponding to a CP in the OFDM symbol may be copied and mapped to the part indicated by reference numeral 938 in the form of extending the CP part of the first SL channel or the last symbol of the first SL channel 932. Accordingly, since a gap between the first SL channel and the second SL channel is 25 μs or less, the UE may utilize the second type channel access method or the third type channel access method.

Method 1-5: Extending a CP of the First Symbol of the Second SL Channel so that the Gap Symbol has a Duration of 25 μs.

Reference numeral 940 indicates a part of the second SL channel 946 being copied and mapped to a part of a symbol as indicated by reference numeral 948. In this case, the length of the part indicated by reference numeral 948 may have a value such that the length of a gap 944 is 25 μs or less, and specifically, the length of the part indicated by reference numeral 948 may have a value of (1 symbol length-25 μs) or more. Copying a part of the second SL channel may mean that a part corresponding to a CP in the OFDM symbol may be copied and mapped to the part indicated by reference numeral 948 in the form of extending the CP part of the second SL channel or the first symbol of the second SL channel 946. Accordingly, since a gap between the first SL channel and the second SL channel is 25 μs or less, the UE may utilize the second type channel access method or the third type channel access method.

Method 1-6: A Combination of Methods 1-4 and 1-5 May be Considered.

In order to make a gap to have a duration of Opts, rather than 25 ρs or less, the SL transmission UE may copy a part of the first SL channel 952 and map the copied part to the first half of the symbol as indicated by reference numeral 954, or extend the CP of first SL channel 952 and map the extended part to the first half of the symbol as indicated by reference numeral 954. In addition, the SL transmission UE may copy a part of a second SL channel 956 and map the copied part to the second half of the symbol as indicated by reference numeral 954, or extend the CP of the second SL channel 956 and map the extended part to the second half of the symbol as indicated by reference numeral 954. Therefore, through the method 1-6, the UE may be able to perform the third type channel access before transmitting the second SL channel.

Among the methods 1-1 to 1-6 above, the SL UE may use one method or a combination of the above methods, or may apply, among a plurality of methods, a method configured using L1 (physical downlink control channel (PDCCH), DCI) or a higher layer signal (RRC, MAC CE) received from a base station or use a preconfigured method.

Alternatively, one of the above methods may be selected according to a higher layer signal (PC5-RRC) or an L1 signal (PSCCH, SCI) transmitted by the SL UE.

As yet another alternative, it may be possible to use different methods depending on a subcarrier spacing. For example, method 1-1 may be applied at a subcarrier spacing of 60 kHz or higher, and at least one combination of methods 1-2 to 1-6 may be applied at a subcarrier spacing of 15 kHz and a subcarrier spacing of 30 kHz.

Alternatively, the UE may be able to select other methods according to the cast type, such as unicast, group cast, or broadcast.

In addition, the above disclosure is only an example, and combinations of at least one of the above methods and obvious variations thereof may be used.

A COT is a period of time during which an SL UE-A operating in an unlicensed band occupies a channel Within the occupied time, the SL UE-A may transmit control and data information to another SL UE-B, or conversely, it may be possible for the UE-B to transmit control and data information to the UE-A. The other SL UE-B is one in case of unicast, and may be two or more in case of group cast or broadcast.

As described above, in case that an SL UE transmits and receives SL channels including one or more pieces of control and data information within a COT in an unlicensed band, it may be advantageous to remove an operation such as performing channel access (e.g., a first type channel access method) when it is unnecessary. For example, in case that an SL UE-A occupies the COT during slots n, (n+1), (n+2), and (n+3) in a situation such as FIG. 8 and the subcarrier spacing is 15 kHz or 30 kHz since there is a gap symbol between each slot, the side link UE-A should additionally perform the same channel access procedure as in the first type channel access method. Consequently, a situation in which slots (n+1), (n+2), and (n+3) are unable to transmit respective control and data information to the SL channel may occur. However, when a subcarrier spacing is 60 kHz or higher, since the gap of one symbol in FIG. 8 is 25 μs or less, the structure of FIG. 8 may be used as is, without considering a separate gap symbol. Therefore, there is a need for a COT having a structure different than that of FIG. 8 at least at a subcarrier spacing of 15 kHz or a subcarrier spacing of 30 kHz.

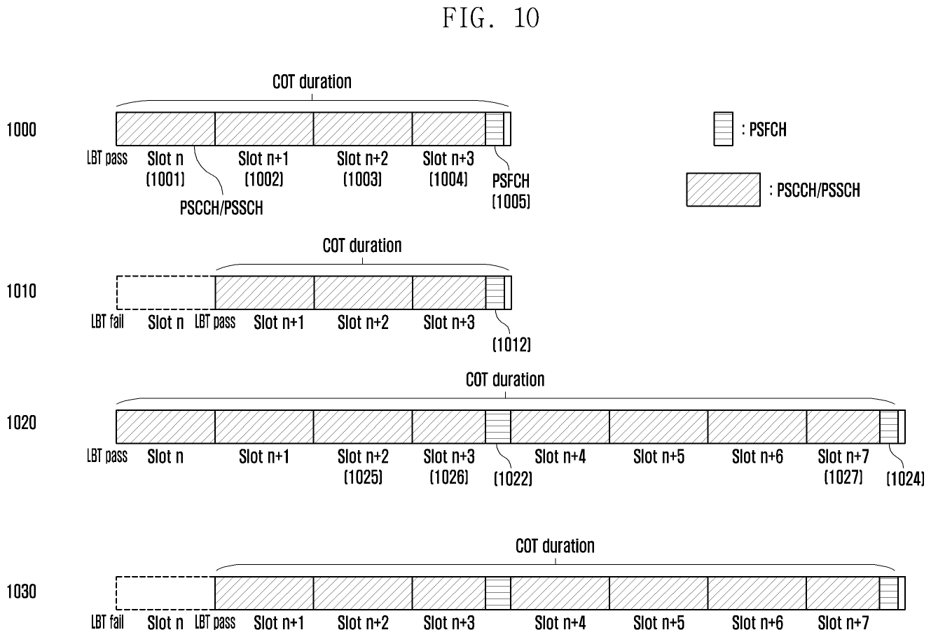

FIG. 10 illustrates a method for configuring a COT duration in an unlicensed band according to an embodiment.

Referring to FIG. 10, an SL UE operating in an unlicensed band may be able to operate by applying at least one of the following methods or some combination thereof.

Method 2-1: The Last SL Channel of a COT Duration is Configured as a PSFCH. As indicated by reference numerals 1000, 1010, 1020, and 1030 of FIG. 10, when the SL UE configures a COT duration, the end of the COT duration may be terminated as the PSFCH. Accordingly, the PSFCH may be allowed to be transmitted without using the first type channel access method.

For example, in case a PSFCH resource is pre-configured to exist every 4 slots, the COT duration configuration is determined according thereto. COT durations may be configured with various lengths such as 4 slots in the case of reference numeral 1000, 3 slots in the case of reference numeral 1010, 8 slots in the case of reference numeral 1020, and/or 7 slots in the case of reference numeral 1030.

An SL UE may include only one PSFCH resource in a COT or may include two or more PSFCH resources.

Alternatively, the SL UE may be able to adaptively select a COT duration according to the priority of packets to be transmitted through the SL, channel access priority, or a SL channel occupancy ratio (or complexity).

For example, when the priority of the packet is high, a UE (hereinafter, referred to as at least one of an SL transmission UE and an SL reception UE) may configure a COT duration to be larger, and when the packet has a lower priority, the UE may configure the COT duration to be small. As such, the size of the COT duration that is maximally occupiable by the UE may be determined according to the packet priority.

For example, when the channel access priority is high, the UE may configure the COT duration to be larger, and when the channel access priority is low, the UE may configure the COT duration to be small. The channel access priority may be determined according to the priority of packets to be transmitted by the UE. The size of the COT duration that is maximally occupiable by the UE according to the channel access priority order may be determined.

Alternatively, when the SL channel occupancy ratio (complexity) is low, the UE may configure the COT duration to be larger, and when the SL channel occupancy ratio (complexity) is high, the UE may configure the COT duration to be small. The channel occupancy may be determined as a value measured by the UE in consideration of at least one of reference signal received power (RSRP), received signal strength indicator (RSSI), or reference signal received quality (RSRQ) during a fixed time interval or a configured time interval. For example, when 20 resources out of a total of 100 resources measured by the UE during 100 slots are greater than the RSRP reference threshold, the channel occupancy ratio of the SL is determined to be 20%. The threshold value may be a fixed value, a configured value, or a value determined according to the priority of packets to be transmitted by the UE among a plurality of candidate values.

In addition, in FIG. 10, reference numerals 1020 and 1030 indicate examples in which a PSFCH is transmitted twice by another UE within a COT duration occupied by a UE, and each PSFCH transmission length may differ according to whether the corresponding PSFCH exists at the last timepoint of the COT or is located in the middle of the COT duration. When the PSFCH is allocated at the end of the COT duration and the PSFCH has a length of 1 or 2 symbols, the UE does not transmit a signal in the last symbol of the slot through which the PSFCH is transmitted (indicated by reference numerals 1012 and 1024). However, when the PSFCH exists in the middle of the COT duration, the PSFCH has a length of 2 symbols or 3 symbols as indicated by reference numerals 1020 and 1030, and the UE may be able to transmit signals without a gap symbols (indicated by reference numeral 1022). Accordingly, at the time of transmitting the PSCCH and the PS SCH in slot (n+4), the UE may perform SL communication without performing the first type channel access method.

Alternatively, the PSFCH resource has a length of 1 symbol or 2 symbols regardless of where it is located within the COT duration, and instead, in a 1 symbol gap that may occur between slot (n+3) and slot (n+4), the UE may operate by applying at least one method among methods 1-1 to 1-6.

Method 2-2: Method 2-1 is a method applicable in a situation where a PSFCH exists, and may be possible even when a PSFCH does not exist. In this case, since the UE does not always need to fix the end of the COT duration to the PSFCH as in Method 2-1, the UE may freely select the COT duration configuration in units of slots.

For example, in reference numeral 1000, when the UE starts channel occupation in slot n, only one slot may be occupied in a COT duration or only two slots may be occupied in the COT duration since a PSFCH does not exist. The number 1 or 2 above is just an example, and other values may be applied.

Alternatively, determination of the size of the COT duration itself, without the PSFCH, is possible by higher layer signal configuration in advance. For example, when a COT consisting of 4 slots may be occupied by higher layer signal configuration, the UE may perform channel occupation only up to slot (n+3) in case that channel occupation is performed in slot n. Here, the 4 slots may refer to a minimum value, a maximum value, or a fixed value. The minimum value is understood as meaning that when the UE occupies a channel, a value of one of the number of slots having the length of COT duration of 4 or more is selected. The maximum value is understood as meaning that when the UE occupies a channel, a value of one of the number of slots having the length of COT duration of 4 or less is selected. The fixed value is understood as meaning that when the UE occupies a channel, the length of the COT duration always has the number of slots of 4.

The above four values are just examples, and other values may be possible. As described above, these values may be determined by higher layer signaling.

Alternatively, the value of the number of a plurality of slots may be configured by a higher layer signal, and one value of among them is determined according to the priority of data to be transmitted by the UE, cast type, or channel occupancy ratio. The priority of the data may refer to the priority of packets or the size of data to be transmitted by the UE.

Method 2-3: As in method 2-1, although the UE configures a COT duration by considering a PSFCH transmission interval, feedback information may be included in the PSFCH or not according to a slot of the PSCCH and PS SCH transmitted in the COT duration.

For example, when in the case of k (k=2) applied to feedback in FIG. 10, HARQ-ACK feedback information that may be included in the PSFCH of slot (n+3) 1004 may correspond to data only for the PSCCH and PSSCH received in at least slot n 1001 and slot (n+1) 1002. In other words, the feedback on the PSCCH and PSSCH received in slot (n+2) 1003 and slot (n+3) 1004 may not be included in a PSFCH 1005 of slot (n+3) 1004. Feedback on the PSCCH and PSSCH received in slot (n+3) 1004 may not be transmitted within the COT of reference numeral 1000 in FIG. 10.

A UE (hereinafter, referred to as UE-1) that has transmitted the PSCCH and PSSCH or a UE (hereinafter, referred to as UE-2) that has received the PSCCH and PSSCH should transmit the PSFCH by occupying a separate channel.

Therefore, HARQ-ACK feedback information on the PSCCH and PSSCH received by UE-2 in slot (n+2) and slot (n+3) may or may not be transmitted depending on whether separate channel occupation is successful or not, and there is a possibility that relatively long time delay occurs. In addition, there may be a problem in that UE-1, which has transmitted the PSCCH and PSSCH, should continuously monitor for feedback reception because it is not known when and at what point the HARQ-ACK feedback information will be transmitted.

In addition, since the determined mapping relationship between the PSCCH and PSS CH resources and the PSFCH resource, which is a method provided in the existing licensed band, cannot be applied in the unlicensed band, UE-2, which has received the PSCCH and PSSCH, may need to include, in the PSFCH, UE-1 ID by which the PSCCH and PSSCH have been transmitted or UE-2 ID information by which the corresponding PSCCH and PSSCH have been received, when transmitting HARQ-ACK feedback information on the PSFCH through a separate COT. Accordingly, HARQ-ACK feedback overhead may increase. Therefore, it may be possible to define from the beginning that UE-2 does not report feedback on the PSCCH and PSSCH received in slot (n+2) and slot (n+3).

In reference numeral 1000, HARQ-ACK feedback for the PSCCH and PSSCH received by UE-2 in slot n 1001 and slot (n+1) 1002 is transmitted on PSFCH 1005 in slot (n+3) 1004, and HARQ-ACK feedback for PSCCH and PSSCH received in slot (n+2) 1003 and slot (n+3) 1004 may not be transmitted. That is, the HARQ-ACK feedback for the PSCCH and PSSCH transmitted in the same or adjacent slot as the slot in which the PSFCH is always transmitted is not transmitted by UE-2 when considering the processing time of UE-2, and this PSFCH may be a PSFCH transmitted by another UE other than UE-2.

For example, in reference numeral 1020 of FIG. 10, the HARQ-ACK feedback for the PSCCH and PSSCH received by UE-2 in slot (n+2) 1025 and slot (n+3) 1026 may be transmitted in a PSFCH 1024 of slot (n+7) 1027. Therefore, in the case of the PSCCH and PSSCH transmitted within the COT duration, whether to transmit or receive HARQ-ACK feedback of UE-2 may be determined according to a slot index in which the PSSCH and PSSCH are transmitted or a distance (or difference) from the slot of the last PSFCH within the COT duration.

A potential disadvantage of the method 2-3 is that UE-1 and UE-2 may not transmit and receive HARQ-ACK feedback information for all of PSCCHs and PSSCHs. Accordingly, data transmission reliability may decrease in the unlicensed band. Therefore, a method for transmitting the HARQ-ACK feedback information by UE-1 or UE-2 occupying a separate channel may be required. This may be called one-shot HARQ-ACK feedback.

The following methods relate to a UE-1 requesting HARQ feedback resources.

Method 3-1: A UE may request HARQ-ACK feedback resources through 1st SCI. When transmitting SCI through the PSCCH, the UE-1 may include information requesting HARQ-ACK feedback resource transmission in the corresponding SCI information. Specifically, the corresponding SCI information may include an ID of the UE-1, an ID of UE-2, and/or a specific HARQ process ID of the UE-2. That is, the UE-1 may receive only the HARQ-ACK feedback from the UE-2 through 1st SCI transmission, without a separate PSSCH transmission.

The HARQ-ACK feedback information transmission performed by the UE-2 may correspond to transmission of HARQ feedback information for all HARQ process IDs configured or fixed for UE-1, or transmission of HARQ feedback information for some HARQ process IDs.

Some HARQ process ID may be indicated through a separate HARQ process indicator included in SCI information. For example, through a 4-bit HARQ process indicator, the UE-2 may be instructed to report HARQ-ACK feedback only for one specific HARQ process ID or to report HARQ feedback only for a specific set of HARQ process IDs.

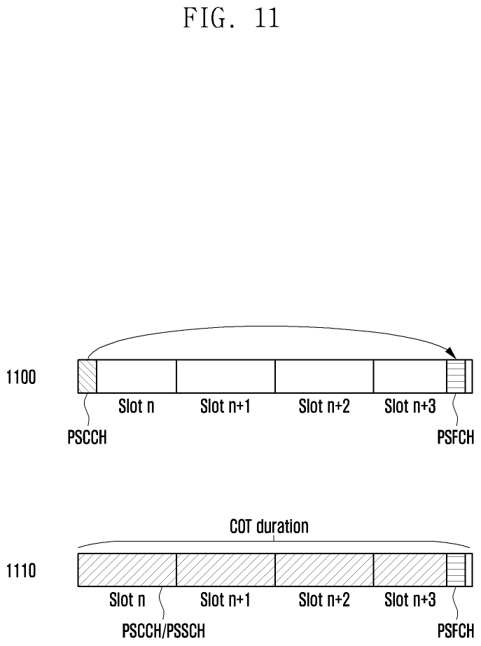

FIG. 11 illustrates a UE requesting HARQ-ACK feedback according to an embodiment.

Referring to FIG. 11, reference numeral 1100 shows an example in which a UE-1 indicates only a PSFCH resource to be used by a UE-2 through a PSCCH, and while there is no resource through which the UE-1 performs signal transmission. Therefore, the UE-2 should use the first type channel access method for the PSFCH transmission. In case that the UE-2 occupies the channel immediately before the PSFCH transmission and transmits the PSCCH and PSSCH, and when the interval with the next transmission PSFCH is 25μs, the UE-2 may perform the PSFCH transmission by using the second type channel access method or the third PSFCH transmission.

Alternatively, as indicated by reference numeral 1110, the UE-1 may separately transmit the PSCCH and PSSCH to the UE-2 or another UE while notifying the PSCCH of a PSFCH resource to be used by the UE-2. Therefore, when the UE-1 occupies a COT duration and the UE-2 transmits the PSFCH scheduled from the UE-1, the UE-1 may transmit the PSFCH in the second type channel access method or the third type channel access method.

Therefore, before transmitting the PSFCH, the UE-2 may determine, before PSFCH transmission, whether the UE-1 operates as in the example of reference numeral 1100 (i.e., there is no resource occupied by UE-1 before the PSFCH transmission of the UE-2) or operates as in the example of reference numeral 1110 (i.e., the UE-1 occupies resources before the PSFCH transmission of the UE-2). This is because the channel access method that the UE-2 should perform for PSFCH transmission differs depending on whether the UE-1 operation corresponds to reference numeral 1100 or 1110. Therefore, whether the UE-1 performs operation 1100 or 1110 may be indicated through a higher layer signal or SCI information. When indicated by SCI information, information indicating PSFCH resources and information indicating whether the UE-1 performs the operation indicated by reference numeral 1100 or 1110 may be included in the same SCI or included in different SCIs.

Alternatively, instead of directly indicating information on whether the UE-1 performs the operation indicated by reference numeral 1100 or 1110, the UE-1 may indicate a channel access method performed by UE-2 (e.g., a first type channel access method or the second type channel access method) through the SCI.

Method 3-2: A UE may indicate HARQ-ACK feedback resources through 2nd SCI. Method 3-1 corresponds to a method in which a UE indicates a HARQ-ACK feedback resource through 1st SCI transmitted through a PSCCH, and method 3-2 corresponds to a method in which the UE-1 indicates a HARQ-ACK feedback resource to be transmitted by the UE-2 through 2nd SCI transmitted through a PSSCH. In this case, the PSSCH transmitting the 2nd SCI may include only 2nd SCI information or data information for UE-2 or other UEs. Other operations are the same as those described above in method 3-1. That is, the UE-1 may optionally indicate whether to perform the operation of reference numeral 1100 or 1110 through higher layer signaling or information included in the 2nd SCI, or may include information indicating a channel access method for a PSFCH transmission of the UE-2 in the 2nd SCI.

The resource for transmitting the HARQ-ACK feedback of the UE-2 indicated by the UE-1 through the above method may be the same as or different from an example of the existing PSFCH transmission resource described based on FIGS. 8 to 10. The transmission resources being different is understood as meaning that the HARQ-ACK feedback is transmitted by the UE-2 in the form of FDM or time division multiplexing (TDM) resources.

In FIGS. 8 to 10, the HARQ-ACK feedback is configured by 1 bit and notifies of whether or not ACK or NACK is transmitted, or when only NACK information is generated, HARQ-ACK feedback regarding NACK is transmitted. However, one-shot HARQ-ACK feedback transmitted by the UE-2 may include information on a plurality of PSCCHs and PSSCHs, and thus the one-shot HARQ-ACK feedback may be configured by information of 2 bits or more and transmitted.

Alternatively, the one-shot HARQ-ACK feedback may be transmitted as 1 bit by bundling HARQ-ACK information regarding reception of a plurality of PSCCHs and PSSCHs. For example, the one-shot HARQ-ACK feedback may be transmitted as 1 bit by bundling 2 bits of HARQ-ACK information with respect to each of the 2 PSSCHs. When each piece of HARQ-ACK information is {ACK, ACK}, the UE may report the HARQ-ACK feedback as an ACK, and when at least one piece of HARQ-ACK information is a NACK, the UE report the HARQ-ACK feedback as a NACK. In case that the UE-2 does not transmit HARQ-ACK feedback in case of an ACK and that UE-2 transmits HARQ-ACK feedback only in case of a NACK, the UE-2 may report the HARQ-ACK feedback as a NACK when at least one piece of HARQ-ACK information is NACK.

Methods 3-1 and 3-2 above describe a case in which the UE-1 instructs to transmit one-shot HARQ-ACK feedback through SCI on PSFCH resources. However, the UE-2 may also transmit one-shot HARQ-ACK feedback without a separate instruction from the UE-1.

For example, the UE-2 may be able to transmit one-shot HARQ-ACK feedback information to the UE-1 using at least one of 1st SCI, 2nd SCI, or PSSCH data format. Accordingly, without the need for the UE-1 to indicate a separate one-shot HARQ-ACK feedback resource, the UE-2 can directly provide one-shot HARQ-ACK feedback information.

Here, at the time of transmitting the one-shot HARQ-ACK feedback to the UE-1, the UE-2 may transmit, together with one-shot HARQ-ACK feedback information, the ID of the UE-1, the ID of the UE-2, or at least a part of HARQ process ID information assigned to the data transmitted and received between the UE-1 and the UE-2 and HARQ process ID information associated with one-shot HARQ-ACK feedback.

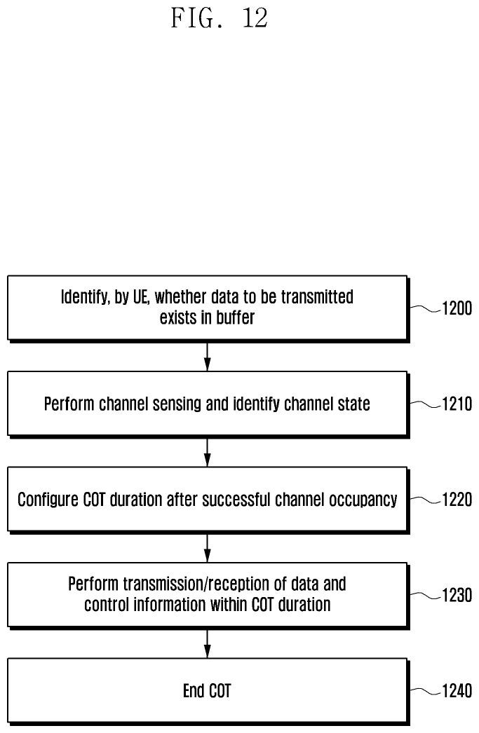

FIG. 12 illustrates a method for configuring a COT duration of a UE according to an embodiment.

Referring to FIG. 12, a UE identifies whether data to be transmitted to another UE exists in a buffer in step 1200. If there is data to be transmitted, the UE performs channel sensing and determines whether the channel is in idle or busy in in step 1210). Here, “idle” refers to a state in which the received energy intensity as a result of channel sensing is less than or equal to a predetermined threshold value, and “busy” refers to a state in which the received energy intensity as a result of channel sensing is greater than or equal to the predetermined threshold value.

In step 1220, the UE occupies the channel and configures a COT duration. The UE configures a COT duration according to at least one of the length of a gap symbol, a processing method of the gap symbol, and the presence or absence of PSFCH transmission resources by considering at least one of the methods described in at least one of FIGS. 9 to 11 and a combination thereof. In addition, the UE performs transmission and reception of control and data information until the end of the COT duration by considering at least one of the methods described in at least one of FIGS. 9 to 11 and a combination thereof within the corresponding COT duration in step 1230. Receiving the control information may include receiving feedback information.

Thereafter, the COT duration ends in step1240.

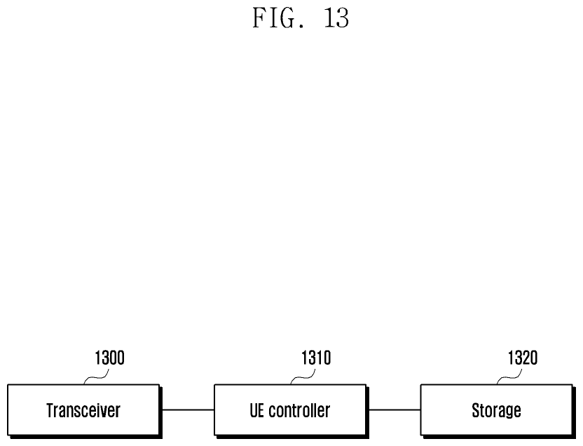

FIG. 13 illustrates a UE according to an embodiment.

Referring to FIG. 13, the UE includes a transceiver 1300, a UE controller 1310, and a storage 1320. The UE controller 1310 may be defined as a circuit, an ASIC, or at least one processor.

The transceiver 1300 may transmit and receive signals to and from another network entity or UE. The transceiver 1300 may receive system information from, e.g., a base station and/or another UE, and may receive an SS or a reference signal (RS).

The UE controller 1310 may control an overall operation of the UE according to any of the embodiments in the disclosure. For example, the UE controller 1310 may control signal flow between blocks to perform operations according to the above-described drawings and flowcharts.

Specifically, the UE controller 1310 operates according to a control signal from the base station or the UE, and may exchange messages or signals with another UE and/or base station.

The storage 1320 may store at least one of information transmitted and received through the transceiver 1300 and information generated through the UE controller 1310.

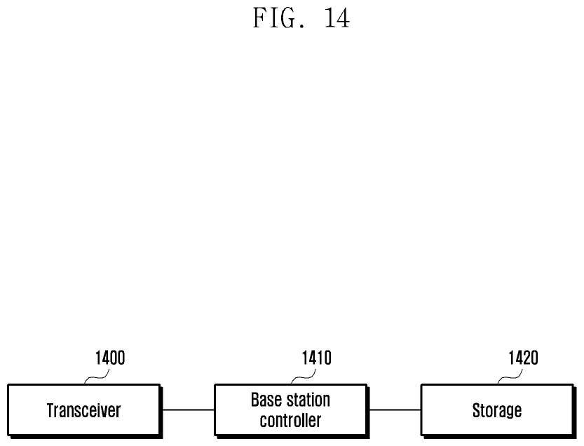

FIG. 14 illustrates a base station according to an embodiment.

Referring to FIG. 14, the base station includes a transceiver 1400, a base station controller 1410, and a storage 1420. The base station controller may be defined as a circuit, an ASIC, or at least one processor.

The transceiver 1400 may transmit and receive signals to and from another network entity or UE. For example, the transceiver may transmit system information to a UE and may transmit an SS or an RS.

The base station controller 1410 may control an overall operation of the base station according to an embodiment of the disclosure. For example, the base station controller 1410 may control operations proposed by the disclosure to manage and reduce interference with neighboring base stations. Specifically, the base station controller 1410 may transmit a control signal to a UE to control the operation of the UE or exchange messages or signals with the UE.

The storage 1420 may store at least one of information transmitted and received through the transceiver 1400 and information generated through the base station controller 1410.

According to the above-described embodiments, a method of configuring SL information and the efficiency of a process of transmitting and receiving the SL information in an SL communication system can be improved.

The embodiments of the disclosure described and shown in the specification and the drawings are merely specific examples that have been presented to easily explain the technical contents of the disclosure and help understanding of the disclosure, and are not intended to limit the scope of the disclosure. Therefore, the scope of the disclosure should be construed to include, in addition to the embodiments disclosed herein, all changes and modifications derived on the basis of the technical idea of the disclosure.

Furthermore, all or a part of a specific embodiment may be performed in combination with all or a part of another embodiment. Of course, performing two or more embodiments in connection or in combination with each other also falls within the scope of the disclosure.

While the disclosure has been particularly shown and described with reference to certain embodiments thereof, it will be understood by those skilled in the art that various changes in form and details may be made therein without departing from the scope of the subject matter as defined by the appended claims and their equivalents.

What is claimed is:

1. A method performed by a first terminal in a communication system, the method comprising:
transmitting, to a second terminal, sidelink (SL) control information scheduling SL data for the second terminal;
transmitting, to the second terminal, the SL data on a physical SL shared channel (PSSCH); and
receiving, from the second terminal, hybrid automatic repeat request (HARQ) feedback associated with the SL data on a physical SL feedback channel (PSFCH) resource,
wherein the SL control information includes an indicator indicating whether the PSFCH resource is included in a channel occupancy time (COT).

2. The method of claim 1, wherein the SL control information further includes information on the PSFCH resource.

3. The method of claim 1, wherein the COT is associated with the PSSCH.

4. A method performed by a second terminal in a communication system, the method comprising:
receiving, from a first terminal, sidelink (SL) control information scheduling SL data, the SL control information including an indicator indicating whether a physical SL feedback channel (PSFCH) resource is included in a channel occupancy time (COT);
receiving, from the first terminal, the SL data on a physical SL shared channel (PSSCH);
identifying hybrid automatic repeat request (HARQ) feedback associated with the SL data; and
transmitting, to the first terminal, the HARQ feedback on the PSFCH resource based on a channel access procedure based on the indicator.

5. The method of claim 4, wherein a type of the channel access procedure corresponds to a first type for a variable period of time in case that the indicator indicates the PSFCH resource is not included in the COT.

6. The method of claim 4, wherein a type of the channel access procedure corresponds to a second type for a fixed period of time or a third type without performing the channel access procedure in case that the indicator indicates the PSFCH resource is included in the COT.

7. The method of claim 4, wherein the COT is associated with the PSSCH.

8. A first terminal in a communication system, the first terminal comprising:
a transceiver; and
a controller coupled with the transceiver and configured to:
transmit, to a second terminal, sidelink (SL) control information scheduling SL data for the second terminal,
transmit, to the second terminal, the SL data on a physical SL shared channel (PSSCH), and
receive, from the second terminal, hybrid automatic repeat request (HARQ) feedback associated with the SL data on a physical SL feedback channel (PSFCH) resource,
wherein the SL control information includes an indicator indicating whether the PSFCH resource is included in a channel occupancy time (COT).

9. The first terminal of claim 8, wherein the SL control information further includes information on the PSFCH resource.

10. The first terminal of claim 8, wherein the COT is associated with the PSSCH.

11. A second terminal in a communication system, the second terminal comprising:
a transceiver;
a controller coupled with the transceiver and configured to:
receive, from a first terminal, sidelink (SL) control information scheduling SL data, the SL control information including an indicator indicating whether a physical SL feedback channel (PSFCH) resource is included in a channel occupancy time (COT),
receive, from the first terminal, the SL data on a physical SL shared channel (PSSCH),
identify hybrid automatic repeat request (HARQ) feedback associated with the SL data, and
transmit, to the first terminal, the HARQ feedback on the PSFCH resource based on a channel access procedure based on the indicator.

12. The second terminal of claim 11, wherein a type of the channel access procedure corresponds to a first type for a variable period of time in case that the indicator indicates the PSFCH resource is not included in the COT.

13. The second terminal of claim 11, wherein a type of the channel access procedure corresponds to a second type for a fixed period of time or a third type without performing the channel access procedure in case that the indicator indicates the PSFCH resource is included in the COT.

14. The second terminal of claim 11, wherein the COT is associated with the PSSCH.
